(19) United States
(12) Patent Application Publication
(10) Pub. No.: US 2014/0140417 A1
(43) Pub. Date: May 22, 2014

(54) SYSTEM AND METHOD FOR PROVIDING ALIGNMENT OF MULTIPLE TRANSCODERS FOR ADAPTIVE BITRATE STREAMING IN A NETWORK ENVIRONMENT

(71) Applicants: Gary K. Shaffer, Topsham, ME (US); Samie Beheydt, Geluwe (BE)

(72) Inventors: Gary K. Shaffer, Topsham, ME (US); Samie Beheydt, Geluwe (BE)

(21) Appl. No.: 13/679,413

(22) Filed: Nov. 16, 2012

(51) Int. Cl. H04N 7/26

(52) U.S. Cl. CPC H04N 19/00545
USPC 375/240.28

(57) ABSTRACT

A method is provided in one example and includes receiving source video including associated video timestamps and determining a theoretical fragment boundary timestamp based upon one or more characteristics of the source video and the received video timestamps. The theoretical fragment boundary timestamp identifies a fragment including one or more video frames of the source video. The method further includes determining an actual fragment boundary timestamp based upon the theoretical fragment boundary timestamp and one or more of the received video timestamps, transcoding the source video according to the actual fragment boundary timestamp, and outputting the transcoded source video including the actual fragment boundary timestamp.

### TECHNICAL FIELD

This disclosure relates in general to the field of communications and, more particularly, to providing alignment of multiple transcoders for adaptive bitrate streaming in a network environment.

### BACKGROUND

Adaptive streaming, sometimes referred to as dynamic streaming, involves the creation of multiple copies of the same multimedia (audio, video, text, etc.) content at different quality levels. Different levels of quality are generally achieved by using different compression ratios, typically specified by nominal bitrates. Various adaptive streaming methods such as Microsoft's HTTP Smooth Streaming “HSS”, Apple's HTTP Live Streaming “HLS”, and Adobe's HTTP Dynamic Streaming “HDS”, MPEG Dynamic Streaming over HTTP “DASH”, involve seamlessly switching between the various quality levels during playback, for example, in response to changes in available network bandwidth. To achieve this seamless switching, the video and audio tracks have special boundaries where the switching can occur. These boundaries are designated in various ways, but should include a timestamp at fragment boundaries. These fragment boundary timestamps should be the same in all of the video tracks and all of the audio tracks of the multimedia content. Accordingly, they should have the same integer numerical value and refer to the same sample from the source content.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for providing alignment of multiple transcoders for adaptive bitrate streaming in a network environment in accordance with one embodiment of the present disclosure;

FIG. 2 is a simplified block diagram illustrating a transcoder device according to one embodiment;

FIG. 3 is a simplified diagram of an example of adaptive bitrate streaming according to one embodiment;

FIG. 4 is a simplified timeline diagram illustrating theoretical fragment boundary timestamps and actual fragment boundary timestamps for a video stream according to one embodiment;

FIG. 5 is a simplified diagram of theoretical fragment boundary timestamps for multiple transcoding profiles according to one embodiment; and

FIG. 6 is a simplified diagram 600 of theoretical fragment boundaries at a timestamp wrap point for multiple transcoding profiles according to one embodiment;

FIG. 7 is a simplified diagram of an example conversion of two AC-3 audio frames to three AAC audio frames in accordance with one embodiment;

FIG. 8 shows a timeline diagram of an audio sample discontinuity due to timestamp wrap in accordance with one embodiment;

FIG. 9 is a simplified flowchart illustrating one potential video synchronization operation associated with the present disclosure; and

FIG. 10 is a simplified flowchart 1000 illustrating one potential audio synchronization operation associated with the present disclosure.

### DETAILED DESCRIPTION OF EXAMPLE EMBODIMENTS

### Overview

A method is provided in one example and includes receiving source video including associated video timestamps and determining a theoretical fragment boundary timestamp based upon one or more characteristics of the source video and the received video timestamps. The theoretical fragment boundary timestamp identifies a fragment including one or more video frames of the source video. The method further includes determining an actual fragment boundary timestamp based upon the theoretical fragment boundary timestamp and one or more of the received video timestamps, transcoding the source video according to the actual fragment boundary timestamp, and outputting the transcoded source video including the actual fragment boundary timestamp.

In more particular embodiments, the one or more characteristics of the source video include a fragment duration associated with the source video and a frame rate associated with the source video. In still other particular embodiments, determining the theoretical fragment boundary timestamp includes determining the theoretical fragment boundary timestamp from a lookup table. In still other particular embodiments, determining the actual fragment boundary timestamp includes determining the first received video timestamp that is greater than or equal to the theoretical fragment boundary timestamp.

In other more particular embodiments, the method further includes determining a theoretical segment boundary timestamp based upon one or more characteristics of the source video and the received video timestamps. The theoretical segment boundary timestamp identifies a segment including one or more fragments of the source video. The method further includes determining an actual segment boundary timestamp based upon the theoretical segment boundary timestamp and one or more of the received video timestamps.

In other more particular embodiments, the method further includes receiving source audio including associated audio timestamps, determining a theoretical re-framing boundary timestamp based upon one or more characteristics of the source audio, and determining an actual re-framing boundary timestamp based upon the theoretical audio re-framing boundary timestamp and one or more of the received audio timestamps. The method further includes transcoding the source audio according to the actual re-framing boundary timestamp, and outputting the transcoded source audio including the actual re-framing boundary timestamp. In more particular embodiments, determining the actual re-framing boundary timestamp includes determining the first received audio timestamp that is greater than or equal to the theoretical re-framing boundary timestamp.

### EXAMPLE EMBODIMENTS

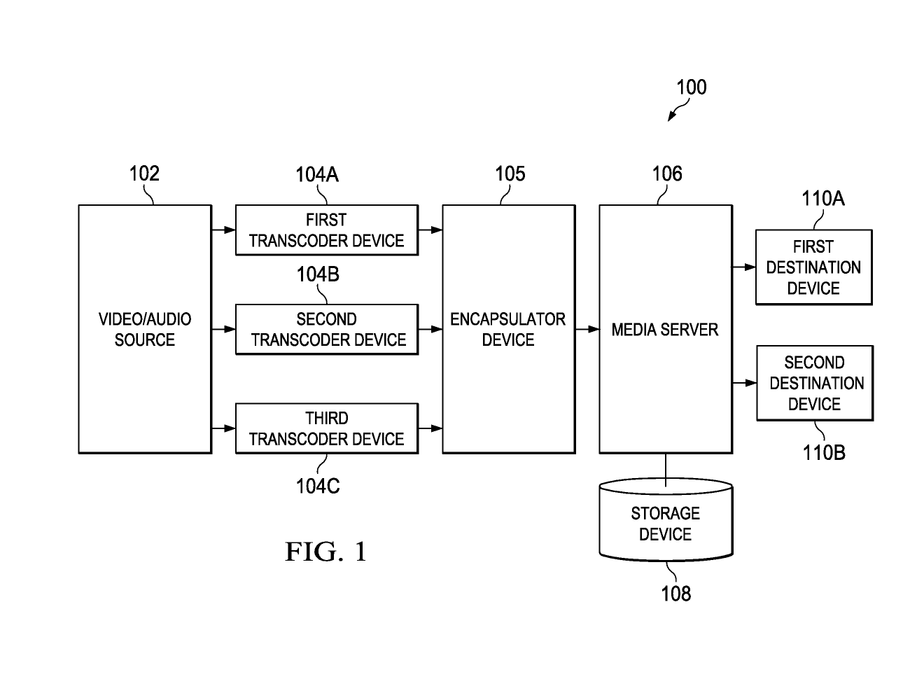

Referring now to FIG. 1, FIG. 1 is a simplified block diagram of a communication system 100 for providing alignment of multiple transcoders for adaptive bitrate streaming in a network environment in accordance with one embodiment of the present disclosure. FIG. 1 includes a video/audio source 102, a first transcoder device 104a, a second transcoder device 104b, and a third transcoder device 104. Communication system 100 further includes an encapsulator device 105, a media server 106, a storage device 108, a first destination device 110a, and a second destination device 110b. Video/audio source 102 is configured to provide source video and/or audio to each of first transcoder device 104a, second transcoder device 104b and third transcoder device 104c. In at least one embodiment, the same source video and/or audio is provided to each of first transcoder device 104a, second transcoder device 104b and third transcoder device 104c.

First transcoder device 104a, second transcoder device 104b, and third transcoder device 104c are each configured to receive the source video and/or audio and transcode the source video and/or audio to a different quality level such as a different bitrate, framerate, and/or format from the source video and/or audio. In particular, first transcoder 104a is configured to produce first transcoded video/audio, second transcoder 104b is configured to produce second transcoded video/audio, and third transcoder 104b is configured to produce third transcoded video/audio. In various embodiments, first transcoded video/audio, second transcoded video/audio, and third transcoded video/audio are each transcoded at a different quality level from each other. First transcoder device 104a, second transcoder device 104b and third transcoder device 104c are further configured to produce timestamps for the video and/or audio such that the timestamps produced by each of first transcoder device 104a, second transcoder device 104b and third transcoder device 104c are in alignment with one another as will be further described herein. First transcoder device 104a, second transcoder device 104b and third transcoder device 104c then each provide their respective timestamp aligned transcoded video and/or audio to encapsulator device 105. Encapsulator device 105 performs packet encapsulation on the respective transcoded video/audio and sends the encapsulated video and/or audio to media server 106.

Media server 106 stores the respective encapsulated video and/or audio and included timestamps within storage device 108. Although the embodiment illustrated in FIG. 1 is shown as including first transcoder device 104a, second transcoder device 104b and third transcoder device 104c, it should be understood that in other embodiments encoder devices may be used within communication system 100. In addition, although the communication system 100 of FIG. 1 shows encapsulator device 105 between transcoder devices 104a-104c, it should be understood that in other embodiments encapsulator device 105 may be located in any suitable location within communication system 100.

Media server 106 is further configured to stream one or more of the stored transcoded video and/or audio files to one or more of first destination device 110a and second destination device 110b. First destination device 110a and second destination device 110b are configured to receive and decode the video and/or audio stream and present the decoded video and/or audio to a user. In various embodiments, the video and/or audio stream provided to either first destination device 110a or second destination device 110b may switch between one of the transcoded video and/or audio streams to another of the transcoded video and/or audio streams, for example, due to changes in available bandwidth, via adaptive streaming. Due to the alignment of the timestamps between each of the transcoded video and/or audio streams, first destination device 110a and second destination device 110b may seamlessly switch between presentation of the video and/or audio.

Adaptive streaming, sometimes referred to as dynamic streaming, involves the creation of multiple copies of the same multimedia (audio, video, text, etc.) content at different quality levels. Different levels of quality are generally achieved by using different compression ratios, typically specified by nominal bitrates. Various adaptive streaming methods such as Microsoft's HTTP Smooth Streaming “HSS”, Apple's HTTP Live Streaming “HLS”, Adobe's HTTP Dynamic Streaming “HDS”, and MPEG Dynamic Streaming over HTTP involve seamlessly switching between the various quality levels during playback, for example, in response to changes in available network bandwidth. To achieve this seamless switching, the video and audio tracks have special boundaries where the switching can occur. These boundaries are designated in various ways, but should include a timestamp at fragment boundaries. These fragment boundary timestamps should be the same for all of the video tracks and all of the audio tracks of the multimedia content. Accordingly, they should have the same integer numerical value and refer to the same sample from the source content.

Several transcoders exist that can accomplish an alignment of timestamps internally within a single transcoder. In contrast, various embodiments described herein provide for alignment of timestamps for multiple transcoder configurations such as those used for teaming, failover, or redundancy scenarios in which there are multiple transcoders encoding the same source in parallel (“teaming” or “redundancy”) or serially (“failover”). A problem that arises when multiple transcoders are used is that although the multiple transcoders are operating on the same source video and/or audio, the transcoders may not receive the same exact sequence of input timestamps. This may be a result of, for example, a transcoder A starting later than a transcoder B. Alternately, this could occur as result of corruption/loss of signal between source and transcoder A and/or transcoder B. Each of the transcoders should still compute the same output timestamps for the fragment boundaries.

Various embodiments described herein provide for aligning of video and audio timestamps for multiple transcoders without requiring communication of state information between transcoders. Instead, in various embodiments described herein first transcoder device 104a, second transcoder device 104b, and third transcoder device 104c “pass through” incoming timestamps to an output and rely on a set of rules to produce identical fragment boundary timestamps and audio frame timestamps from each of first transcoder device 104a, second transcoder device 104b, and third transcoder device 104c. Discontinuities in the input source, if they occur, are passed through to the output. If the input to the transcoder(s) is continuous and all frames have an explicit Presentation Time Stamp (PTS) value, then the output of the transcoder(s) can be used directly by an encapsulator. In practice, it is likely that there will be at least occasional loss of the input signal, and some input sources group multiple video frames into one packetized elementary stream (PES) packet. In order to be tolerant of all possible input source characteristics, it is possible that there will still be some differences in the output timestamps of two transcoders that are processing the same input source. However, the procedures as described in various embodiments result in “aligned” outputs that can be “finalized” by downstream components to meet their specific requirements without having to re-encode any of the video or audio. Specifically, in a particular embodiment, the video closed Group of Pictures (GOP) boundaries (i.e. Instantaneous Decoder Refresh (IDR) frames) and the audio frame boundaries will be placed consistently. The timestamps of the transcoder input source may either be used directly as the timestamps of the aligned transcoder output, or they may be embedded elsewhere in the stream, or both. This allows downstream equipment to make any adjustments that may be necessary for decoding and presentation of the video and/or audio content.

Various embodiments are described with respect to a ISO standard 13818-1 MPEG2 transport stream input/output to a transcoder, however the principles described herein are similarly applicable to other types of video streams such as any system in which an encoder ingests baseband (i.e. SDI or analog) video or an encoder/transcoder that outputs to a format other than, for example, an ISO 13818-1 MPEG2 transport stream.

An MPEG2 transport stream transcoder receives timestamps in Presentation Time Stamp (PTS) “ticks” which represent 1/90000 of 1 second. The maximum value of the PTS tick is 2̂33 or 8589934592, approximately 26.5 hours. When it reaches this value it “wraps” back to a zero value. In addition to the discontinuity introduced by the wrap, there can be jumps forward or backward at any time. An ideal source does not have such jumps, but in reality such jumps often do occur. Additionally, it cannot be assumed that all video and audio frames will have an explicit PTS associated with them.

First, assume a situation in which the frame rate of the source video is constant and there are no discontinuities in the source video. In such a situation, video timestamps may then simply be passed through the transcoder. However there is an additional step of determining which video timestamps are placed as fragment boundaries. To ensure that all transcoders place fragment boundaries consistently, the transcoders compute nominal frame boundary PTS values based on the nominal frame rate of the source and a user-specified nominal fragment duration. For example, for a typical frame rate of 29.97 fps (30/1.001), the frame duration is 3003 ticks. In a particular embodiment, the nominal fragment duration can be specified in terms of frames. In a specific embodiment, the nominal fragment duration may be set to a typical value of sixty (60) frames. In this case, the nominal fragment boundaries may be set at 0, 180180, 360360, etc. The first PTS value received that is equal to or greater than a nominal boundary and less than the next nominal boundary may be used as an actual fragment boundary.

For an ideal source having a constant frame rate and no discontinuities, the above-described procedure produces the same exact fragment boundary timestamps on each of multiple transcoders. In practice, the transcoder input may have at least occasional discontinuities. In the presence of discontinuities, if first transcoder device 104a receives a PTS at 180180 and second transcoder device 104bB does not, then each of first transcoder device 104a and second transcoder device 104b may produce one fragment with mismatched timestamps (180180 vs. 183183 for example). Downstream equipment, such as an encapsulator associated with media server 106, may detect this difference and compensate as required. The downstream equipment may, for example, use knowledge of the nominal boundary locations and the original input PTS values to the transcoders. To allow for reduced video frame rate in some of the output streams, care has to be taken to ensure that the lower frame rate streams do not discard the video frame that the higher frame rate stream(s) would select as their fragment boundary frame. Various embodiments of video boundary PTS alignment are further described herein.

With audio, designating fragment boundaries can be performed in a similar manner as to video if needed. However, there is an additional complication with audio streams, because while it is not always necessary to designate fragment boundaries, it is necessary to group audio samples into frames. In addition, it is often impossible to pass through audio timestamps because input audio frame duration is often different from output audio frame duration. The duration of an audio frame depends on the audio compression format and audio sample rate. Typical input audio compression formats are AC-3 developed by Dolby Laboratories, Advanced Audio Coding (AAC), and MPEG. A typical input audio sample rate is 48 kHz. Most of the adaptive streaming specs support AAC with a sample rates from the 48 kHz “family” (48 kHz, 32 kHz, 24 kHz, 16 kHz . . . ) and the 44.1 kHz family (44.1 kHz, 22.05 kHz, 11.025 kHz . . . ).

Various embodiments described herein exploit the fact that while audio PTS values cannot be passed through directly, there can still be a deterministic relationship between the input timestamp and output timestamp. Regarding an example in which the input is 48 kHz AC-3 and the output is 48 kHz AAC. In this case, every 2 AC-3 frames form 3 AAC frames. Of each pair of input AC-3 frame PTS values, the first or “even” AC3 PTS is passed through as the first AAC PTS, and the remaining two AAC PTS values (if needed) are extrapolated from the first by adding 1920 and 3840. For each AC3 PTS a determination is made whether the given AC3 PTS is “even” or “odd.” In various embodiments, the determination of whether a particular PTS is even or odd can be determined either via a computation or equivalent lookup table. Various embodiments of audio frame PTS alignment are further described herein.

In one particular instance, communication system 100 can be associated with a service provider digital subscriber line (DSL) deployment. In other examples, communication system 100 would be equally applicable to other communication environments, such as an enterprise wide area network (WAN) deployment, cable scenarios, broadband generally, fixed wireless instances, fiber to the x (FTTx), which is a generic term for any broadband network architecture that uses optical fiber in last-mile architectures. Communication system 100 may include a configuration capable of transmission control protocol/internet protocol (TCP/IP) communications for the transmission and/or reception of packets in a network. Communication system 100 may also operate in conjunction with a user datagram protocol/IP (UDP/IP) or any other suitable protocol, where appropriate and based on particular needs.

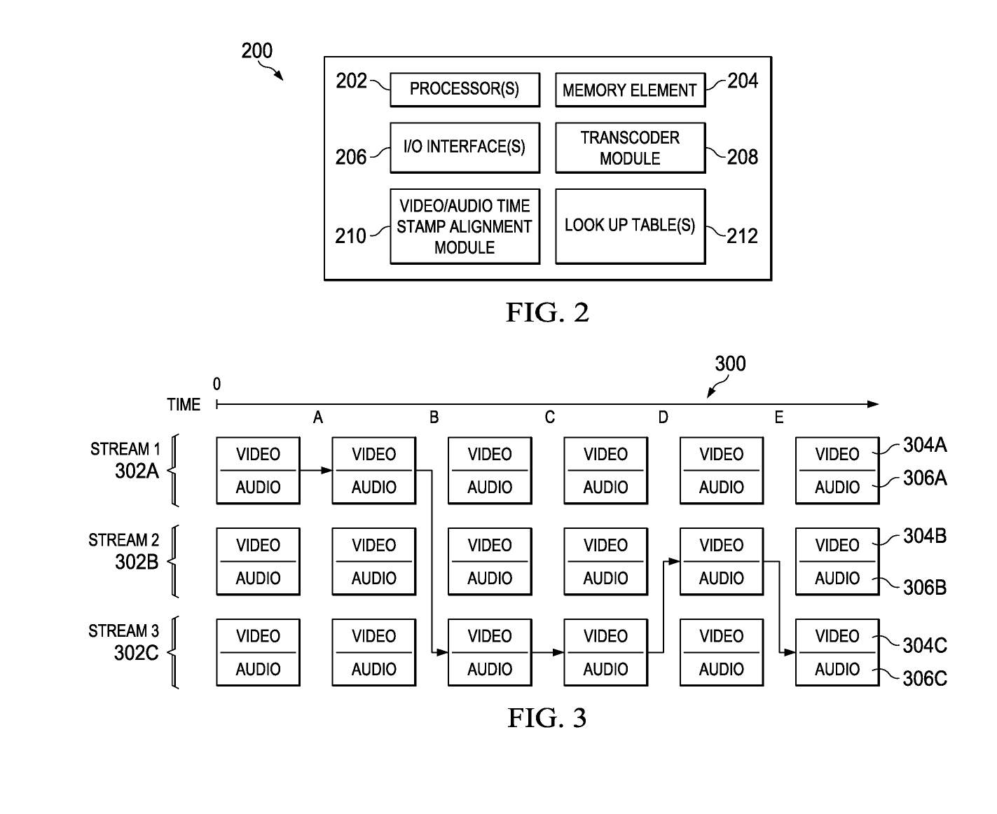

Referring now to FIG. 2, FIG. 2 is a simplified block diagram illustrating a transcoder device 200 according to one embodiment. Transcoder device 200 includes processor(s) 202, a memory element 204, input/output (I/O) interface(s) 206, transcoder module(s) 208, a video/audio timestamp alignment module 210, and lookup table(s) 212. In various embodiments, transcoder device 200 may be implemented as one or more of first transcoder device 104a, second transcoder device 104b, and third transcoder device 104c of FIG. 1. Processor(s) 202 is configured to execute various tasks of transcoder device 200 as described herein and memory element 1204 is configured to store data associated with transcoder device 200. I/O interfaces(s) 206 is configured to receive communications from and send communications to other devices or software modules such as video/audio source 102 and media server 106. Transcoder module(s) 208 is configured to receive source video and/or source audio and transcode the source video and/or source audio to a different quality level. In a particular embodiment, transcoder module(s) 208 transcodes source video and/source audio to a different bit rate, frame rate, and/or format. Video/audio timestamp alignment module 210 is configured to implement the various functions of determining, calculating, and/or producing aligned timestamps for transcoded video and/or audio as further described herein. Lookup table(s) 212 is configured to store lookup table values of theoretical video fragment/segment boundary timestamps, theoretical audio re-framing boundary timestamps, and/or any other lookup table values, which may be used during the generation of the aligned timestamps as further, described herein.

In one implementation, transcoder device 200 is a network element that includes software to achieve (or to foster) the transcoding and/or timestamp alignment operations as outlined herein in this Specification. Note that in one example, each of these elements can have an internal structure (e.g., a processor, a memory element, etc.) to facilitate some of the operations described herein. In other embodiments, these transcoding and/or timestamp alignment operations may be executed externally to this element, or included in some other network element to achieve this intended functionality. Alternatively, transcoder device 200 may include software (or reciprocating software) that can coordinate with other network elements in order to achieve the operations, as outlined herein. In still other embodiments, one or several devices may include any suitable algorithms, hardware, software, components, modules, interfaces, or objects that facilitate the operations thereof.

In order to support video and audio services for Adaptive Bit Rate (ABR) applications, there is a need to synchronize both the video and audio components of these services. When watching video services delivered over, for example, the internet, the bandwidth of the connection can change over time. Adaptive bitrate streaming attempts to maximize the quality of the delivered video service by adapting its bitrate to the available bandwidth. In order to achieve this, a video service is encoded as a set of several different video output profiles, each having a certain bitrate, resolution and framerate. Referring again to FIG. 1, each of first transcoder device 104a, second transcoder device 104b, and third transcoder device 104c may each encode and/or transcode source video and/or audio received from video/audio source 102 according to one or more profiles wherein each profile has an associated bitrate, resolution, framerate, and encoding format. In one or more embodiments, video and/or audio of these different profiles are chopped in “chunks” and stored as files on media server 106. At a certain point in time a client device, such as first destination device 110a, requests the file that best meets its bandwidth constraints which can change over time. By seamlessly “gluing” these chunks together, the client device may provide a seamless experience to the consumer.

Since combining files from different video profiles should result in a seamless viewing experience, video chunks associated with the different profiles should be synchronized in a frame-accurate way, i.e. the corresponding chunk of each profile should start with exactly the same frame to avoid discontinuities in the presentation of the video/audio content Therefore, when generating the different profiles for a video source, the encoders that generate the different profiles should be synchronized in a frame-accurate way. Moreover, each chunk should be individually decodable. In a H264 data stream, for example, each chunk should start with an instantaneous decoder refresh (IDR) frame.

A video service normally also contains one or more audio elementary streams. Typically, audio content is stored together with the corresponding video content in the same file or as a separate file on the file server. When switching from one profile to another, the audio content may be switched together with the video. In order to provide a seamless listening experience, chunks should start with a new audio frame and corresponding chunks of the different profiles should start with exactly the same audio sample.

Referring now to FIG. 3, FIG. 3 is a simplified diagram 300 of an example of adaptive bitrate streaming according to one embodiment. In the example illustrated a first video/audio stream (Stream 1) 302a, a second video/audio stream (Stream 2) 302b, and a third video/audio stream (Stream 3) 302c are transcoded from a common source video/audio received from video/audio source 102 by first transcoder device 104a, second transcoder device 104b, and third transcoder device 104c and stored by media server 106 within storage device 108. In the example of FIG. 3, first video/audio stream 302a is transcoded at a higher bitrate than second video/audio stream 302b, and second video/audio stream 302b is encoded at a higher bitrate than third video/audio stream 302c. First video/audio stream 302a includes first video stream 304a and first audio stream 306a, second video/audio stream 302b includes second video stream 304b and second audio stream 306b, and third video/audio stream 302c includes third video stream 304c and third audio stream 306c.

At a Time 0, first destination device 110a begins receiving video/audio stream 302a from media server 106 according the bandwidth available to first destination device 110a. At Time A, the bandwidth available to first destination device 110a remains sufficient to provide first video/audio stream 302a to first destination device 110a. At Time B, the bandwidth available to first destination device 110a is greatly reduced, for example due to network congestion. According to an adaptive bitrate streaming procedure, first destination device 110a begins receiving third audio/video stream 302c. At Time C, the bandwidth available to first destination device 110a remains reduced and first destination device 110a continues to receive third video/audio stream 302c. At Time D, greater bandwidth is available to first destination device 110a and first destination device 110a begins receiving second video/audio stream 302b from media server 106. At Time E, the bandwidth available to first destination device 110a is again reduced and first destination device 110a begins receiving third video/audio stream 302c once again. As a result of adaptive bitrate streaming, first destination device 110a continues to seamlessly receive a representation of the original video/audio source despite variations in the network bandwidth available to first destination device 110a.

As discussed, there is a need to synchronize the video over the different video profiles in the sense that corresponding chunks, also called fragments or segments (segments being typically larger than fragments), should start with the same video frame. In some cases, a segment may be comprised of an integer number of fragments although this is not required. For example, when two chunk sizes are being produced simultaneously in which the smaller chunks are called fragments and the larger chunks are called segments, the segments are typically sized to be an integer number of fragments. In various embodiments, the different output profiles can be generated either in a single codec chip, in different chips on the same board, in different chips on different boards in the same chassis, or in different chips on boards, for example. Regardless of where these profiles are generated, the video associated with each profile should be synchronized.

One procedure that could be used for synchronization is to use a master/slave architecture in which one codec is the synchronization master that generates one of the profiles and decides where the fragment/segment boundaries are. The master communicates these boundaries in real-time to each of the slaves and the slaves perform based upon what the master indicates should be done. Although this is conceptually a relatively simple solution, it is difficult to implement properly because it is not easily amendable to the use of backup schemes and configuration is complicated and time consuming.

In accordance with various embodiments described herein, each of first transcoder device 104a, second transcoder device 104b, and third transcoder device 104c use timestamps in the incoming service, i.e. a video and/or audio source, as a reference for synchronization. In a particular embodiment, a PTS within the video and/or audio source is used as a timestamp reference. In a particular embodiment, each transcoder device 104a-104c receives the same (bit-by-bit identical) input service with the same PTS's. In various embodiments, each transcoder uses a pre-defined set of deterministic rules to perform a synchronization process given the incoming PTS's. In various embodiments, rules define theoretical fragmentation/segmentation boundaries, expressed as timestamp values such as PTS values. In at least one embodiment, these boundaries are solely determined by the fragment/segment duration and the frame rate of the video.

First Video Synchronization Procedure

Theoretical Fragment and Segment Boundaries

In one embodiment of a video synchronization procedure theoretical fragment and segment boundaries are determined. In a particular embodiment, theoretical fragment boundaries are determined by following rules:

A first theoretical fragment boundary, PTS_F_{theo[1]}, starts at:

PTS_{—}F_{theo[1]}=0

Theoretical fragment boundary n starts at:

PTS_{—}Ftheo[n]=(n−1)*Fragment Length

With: Fragment Length=fragment length in 90 kHz ticks

The fragment length expressed in 90 kHz ticks is calculated as follows:

FragmentLength=90000/FrameRate*ceiling(FragmentDuration*FrameRate)
With: Framerate=number of frames per second in the video input
   Fragment Duration=duration of the fragment in seconds
   ceiling(x)=ceiling function which rounds up to the nearest integer
The ceiling function rounds the fragment duration (in seconds) up to an integer number of frames.

An issue that arises with using a PTS value as a time reference for video synchronization is that the PTS value wraps around back to zero after approximately 26.5 hours. In general one PTS cycle will not contain an integer number of equally-sized fragments. In order to address this issue in at least one embodiment, the last fragment in the PTS cycle will be extended to the end of the PTS cycle. This means that the last fragment before the wrap of the PTS counter will be longer than the other fragments and the last fragment ends at the PTS wrap.

The last theoretical normal fragment boundary in the PTS cycle starts at following PTS value:

PTS_{—}F_{theo[Last-1]}=[floor(2̂33/FragmentLength)−2]*FragmentLength
With: floor(x)=floor function which rounds down to the nearest integer
The very last theoretical fragment boundary in the PTS cycle (i.e. the one with extended length) starts at following PTS value:

PTS_{—}F_{theo[Last]}=PTS_{—}F_{theo[Last-1]}+FragmentLength

As explained above a segment is a collection of an integer number of fragments. Next to the rules to define the theoretical fragment boundaries, there is also a need to define the theoretical segment boundaries.
The first theoretical segment boundary, PTS_S_{theo[1]}, coincides with the first fragment boundary and is given by:

PTS_{—}S_{theo[1]}=0
Theoretical segment boundary n starts at:

PTS_{—}S_{theo[n]}=(n−1)*Fragment Length*N
With: Fragment Length=fragment length in 90 kHz ticks
   N=number of fragments/segment

Just like for fragments, the PTS cycle will not contain an integer amount of equally-sized segments and hence the last segment will contain less fragments than the other segments.

The last normal segment in the PTS cycle starts at following PTS value:

PTS_{—}S_{theo[Last-1]}=[floor(2̂33/(FragmentLength*N))−2]*(FragmentLength*N)
The very last segment in the PTS cycle (containing less fragments) starts at following PTS value:

PTS_{—}S_{theo[Last]}=PTSLast-1+FragmentLength*N

Actual Fragment and Segment Boundaries

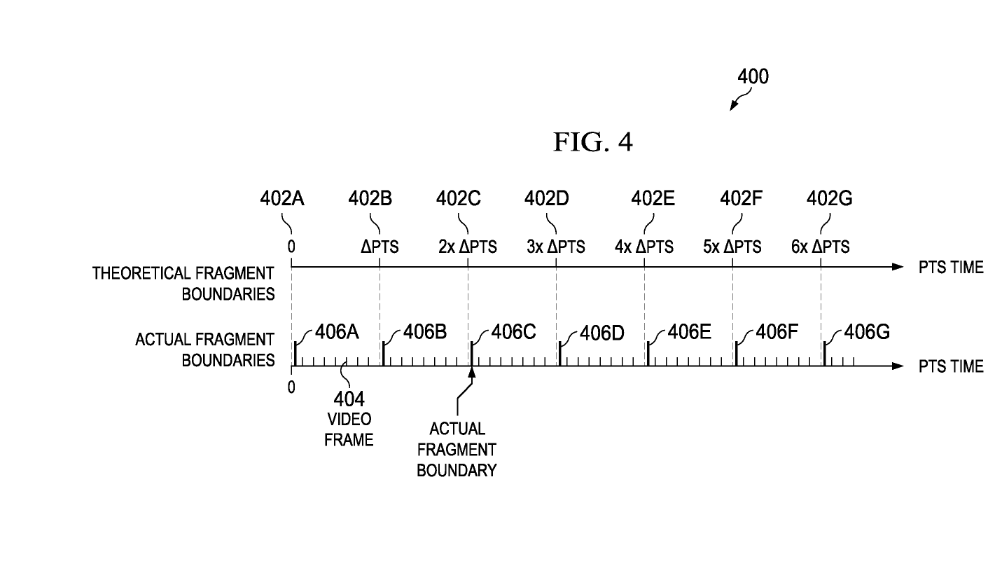

Referring now to FIG. 4, FIG. 4 is a simplified timeline diagram 400 illustrating theoretical fragment boundary timestamps and actual fragment boundary timestamps for a video stream according to one embodiment. In the previous section the theoretical fragment and segment boundaries were calculated. The theoretical boundaries are used to determine the actual boundaries. In accordance with at least one embodiment, actual fragment boundary timestamps are determined as follows: the first incoming actual PTS value that is greater than or equal to PTS_F_{theo[n]} determines an actual fragment boundary timestamp, and the first incoming actual PTS value that is greater than or equal to PTS_S_{theo[n]} determines an actual segment boundary timestamp. The timeline diagram 400 of FIG. 4 shows a timeline measured in PTS time. In the timeline diagram 400, theoretical fragment boundary timestamps 402a-402g calculated according to the above-described procedure are indicated in multiples of ΔPTS, where ΔPTS is the theoretical PTS timestamp period. In particular, a first theoretical fragment boundary timestamp is indicated at time 0 (zero), a second theoretical fragment boundary timestamp 402b is indicated at time ΔPTS, a third theoretical fragment boundary timestamp 402c is indicated at time 2×ΔPTS, a fourth theoretical fragment boundary timestamp 402d is indicated at time 3×ΔPTS, a fifth theoretical fragment boundary timestamp 402e is indicated at time 4×ΔPTS, and sixth theoretical fragment boundary timestamp 402f is indicated at time 5×ΔPTS, and a seventh theoretical fragment boundary timestamp 402g is indicated at time 6×ΔPTS. The timeline 400 further includes a plurality of video frames 404 having eight frames within each ΔPTS time period. Timeline 400 further includes actual fragment boundary timestamps 406a-406g located at the first video frame 404 falling after each ΔPTS time period. In the embodiment of FIG. 4, actual fragment boundary timestamps 406a-406g are calculated according to the above-described procedure. In particular, a first actual fragment boundary timestamp 406a is located at the first video frame 404 occurring after time 0 of first theoretical fragment boundary timestamp 402a. In addition, a second actual fragment boundary timestamp 406b is located at the first video frame 404 occurring after time ΔPTS of second theoretical fragment boundary timestamp 402b, a third actual fragment boundary timestamp 406c is located at the first video frame 404 occurring after time2×ΔPTS of third theoretical fragment boundary timestamp 402c, a fourth actual fragment boundary timestamp 406d is located at the first video frame 404 occurring after time 3×ΔPTS of third theoretical fragment boundary timestamp 402c, a fifth actual fragment boundary timestamp 406e is located at the first video frame 404 occurring after time 4×ΔPTS of fifth theoretical fragment boundary timestamp 402e, a sixth actual fragment boundary timestamp 406f is located at the first video frame 404 occurring after time 5×ΔPTS of sixth theoretical fragment boundary timestamp 402f, and a seventh actual fragment boundary timestamp 406g is located at the first video frame 404 occurring after time 6×ΔPTS of seventh theoretical fragment boundary timestamp 406g.

As discussed above the theoretical fragment boundaries depend upon the input frame rate. The above description is applicable for situations in which the output frame rate from the transcoder device is identical to the input frame rate received by the transcoder device. However, for ABR applications the transcoder device may generate video corresponding to different output profiles that may each have a different frame rate from the source video. Typical reduced output frame rates used in ABR are output frame rates that are equal to the input framerate divided by 2, 3 or 4. Exemplary resulting output frame rates in frames per second (fps) are shown in the following table (Table 1) in which frame rates below approximately 10 fps are not used:

TABLE 1

| Input FR (fps) | /2 (fps) | /3 (fps) | /4 (fps) |
|---|---|---|---|
| 50 | 25 | 16.67 | 12.5 |
| 59.94 | 29.97 | 19.98 | 14.99 |
| 25 | 12.5 | — | — |
| 29.97 | 14.99 | 9.99 | — |

When limiting the output frame rates to an integer division of the input framerate an additional constraint is added to ensure that all output profiles stay in synchronization. According to various embodiments, when reducing the input frame rate by a factor x, one input frame out of the x input frames is transcoded and the other x−1 input frames are dropped. The first frame that is transcoded in a fragment should be the frame that corresponds with the actual fragment boundary. All subsequent x−1 frames are dropped. Then the next frame is transcoded again, the following x−1 frames are dropped and so on.

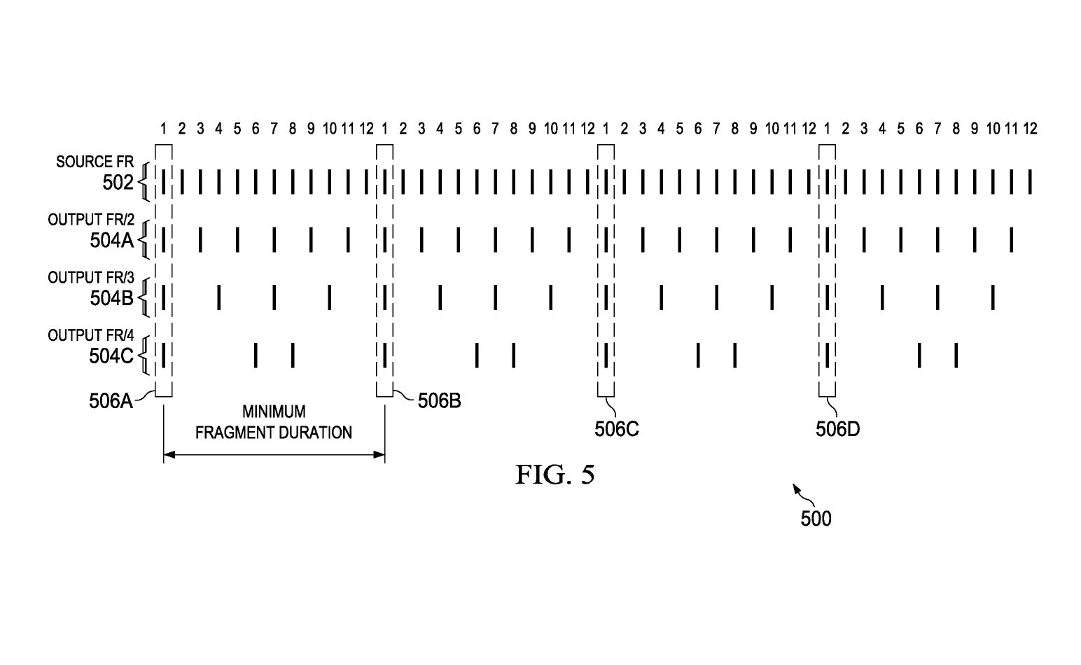

Referring now to FIG. 5, FIG. 5 is a simplified diagram 500 of theoretical fragment boundary timestamps for multiple transcoding profiles according to one embodiment. An additional constraint on the theoretical fragment boundaries is that each boundary should start with a frame that belongs to each of the output profiles. In other words, the fragment duration is a multiple of each of the output profile frame periods. If the framerate divisors are x₁, x₂ and x₃, this is achieved by making the fragment duration a multiple of the least common multiple (lcm) of x₁, x₂ and x₃. For example, in a case of x₁=2, x₂=3 and x₃=4, the least common multiple calculation lcm(x₁, x₂, x₃)=12. Accordingly, the minimum fragment duration in this example is equal to 12. FIG. 5 shows source video 502 having a predetermined framerate (FR) in which there are twelve frames of source video 502 within each minimum fragment duration. A first transcoded output video 504a has a frame rate that is one-half (FR/2) that of source video 502 and includes six frames of first transcoded output video 504a within the minimum fragment duration. A second transcoded output video 504b has a frame rate that is one-third (FR/3) that of source video 502 and includes four frames of second transcoded output video 504b within the minimum fragment duration. A third transcoded output video 504c has a frame rate that is one-fourth (FR/4) that of source video 502 and includes three frames of third transcoded output video 504c within the minimum fragment duration. As illustrated in FIG. 5, the output frames of each of first transcoded output video 504a, second transcoded output video 504b, and third transcoded output video 504c coincide at the least common multiple of 2, 3, and 4 equal to 12.

FIG. 5 shows a first theoretical fragment boundary timestamp 506a, a second theoretical fragment boundary timestamp 506b, a third theoretical fragment boundary timestamp 506c, and a fourth theoretical fragment boundary timestamp 506d at each minimum fragment duration of the source video 502 placed at the theoretical fragment boundaries. In accordance with various embodiments, the theoretical fragment boundary timestamp 506a-506d associated with first transcoded output video 504a, second transcoded output video 504b, and third transcoded output video 504c is the same at each minimum fragment duration as the timestamp of the corresponding source video 502 at the same instant of time. For example, first transcoded output video 504a, second transcoded output video 504b, and third transcoded output video 504c will have the same first theoretical fragment boundary timestamp 506a encoded in association therewith. Similarly, first transcoded output video 504a, second transcoded output video 504b, and third transcoded output video 504c will have the same second theoretical fragment boundary timestamp 506b, same third theoretical fragment boundary timestamp 506c, and same fourth theoretical fragment boundary timestamp 506d at their respective video frames corresponding to that instance of source video 502.

The following table (Table 2) gives an example of the minimum fragment duration for the different output frame rates as discussed above. All fragment durations that are a multiple of this value are valid durations.

TABLE 2

minimum Fragment

| Input FR | lcm(x1, x2, . . . ) | 90 kHz ticks | s |
|---|---|---|---|
| 50.00 | 12 | 21600 | 0.240 |
| 59.94 | 12 | 18018 | 0.200 |
| 25.00 | 2 | 7200 | 0.080 |
| 29.97 | 6 | 18018 | 0.200 |

Table 2 shows input frame rates of 50.00 fps, 59.94 fps, 25.00 fps, and 29.97 fps along with corresponding least common multiples, and minimum fragment durations. The minimum fragment durations are shown in both 90 kHz ticks and seconds (s).

Frame Alignment at PTS Wrap

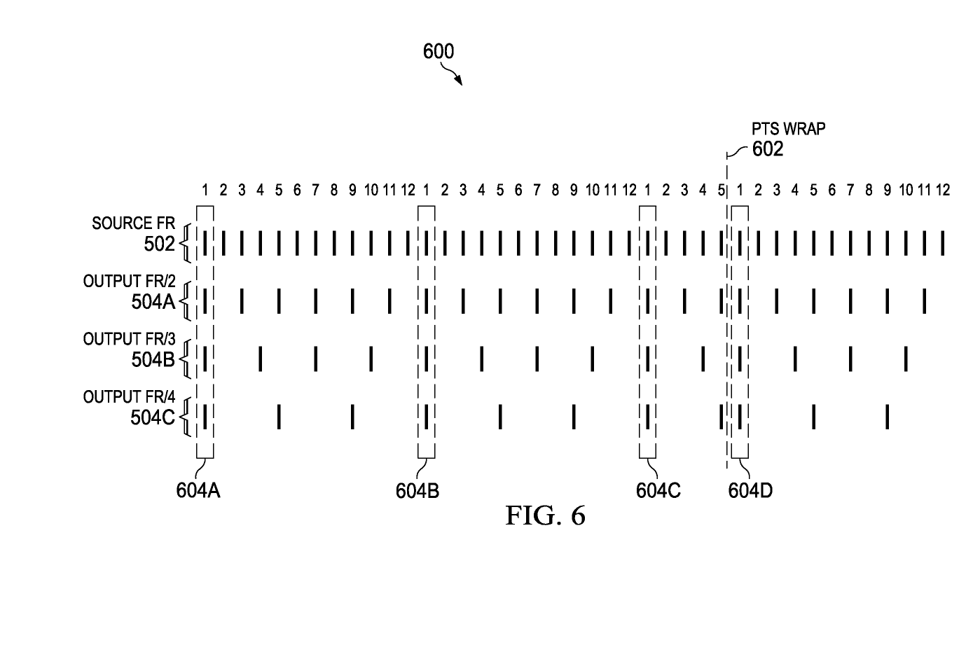

Referring now to FIG. 6, FIG. 6 is a simplified diagram 600 of theoretical fragment boundaries at a timestamp wrap point for multiple transcoding profiles according to one embodiment. When handling frame rate reduced output profiles as described hereinabove, an issue may occur at the PTS wrap point. Normally each fragment/segment duration is a multiple of all frame rate divisors and the frames of all profiles are equally spaced (i.e. have a constant PTS increment). At the PTS wrap point however, a new fragment/segment is started and the previous fragment/segment length may not be a multiple of the frame rate divisors. FIG. 6 shows a PTS wrap point 602 within the first transcoded output video 504a, second transcoded output video 504b, and third transcoded output video 504c where a fragment size of 12 frames is used. FIG. 6 further includes theoretical fragment boundary timestamps 604a-604d. In the example illustrated in FIG. 6 one can see that because of the location of PTS wrap point 602 prior to theoretical fragment boundary timestamp 604d there is a discontinuity on the PTS increment for all framerate reduced profiles. Depending on the client device this discontinuity may or may not introduce visual artifacts in the presented video. If such discontinuities are not acceptable, a second procedure for synchronization of video timestamps may be used as further described below.

Second Video Synchronization Procedure

In order to accommodate the PTS discontinuity issue at the PTS wrap point for frame rate reduced profiles, a modified video synchronization procedure is described. Instead of considering just one PTS cycle for which the first theoretical fragment/segment boundary starts at PTS=0, in accordance with another embodiment of a video synchronization procedure multiple successive PTS cycles are considered. Depending upon the current cycle as determined by the source PTS values, the position of the theoretical fragment/segment boundaries will change.

In at least one embodiment, the first cycle starts arbitrarily with a theoretical fragment/segment boundary at PTS=0. The next fragment boundary starts at PTS=Fragment Length, and so on just as described for the previous procedure. At the wrap of the first PTS cycle, the next fragment boundary timestamp doesn't start at PTS=0 but rather at the last fragment boundary of the first PTS cycle+Fragment Length (modulo 2̂33). In this way, the fragments and segments have the same length at the PTS wrap and no PTS discontinuities occur for the frame rate reduced profiles. Given the video frame rate, the number of frames per fragment and the number of fragments per segment, in a particular embodiment a lookup table 212 (FIG. 2) is built that contains all fragment and segment boundaries for all PTS cycles. Upon reception of an input PTS value, the current PTS cycle is determined and a lookup is performed in lookup table 212 to find the next fragment/segment boundary.

In one or more embodiments, the total number of theoretical PTS cycles that needs to be considered is not infinite. After a certain number of cycles the first cycle will be arrived at again. The total number of PTS cycles that need to be considered can be calculated as follows:

#PTSCycles=lcm(2̂33, 90000/Frame Rate)/2̂33

The following table (Table 3) provides two examples for the number of PTS cycles that need to be considered for different frame rates.

TABLE 3

| FrameRate | |
|---|---|
| (Hz) | Numbe Of PTS Cycles |
| 25/50 | 225 |
| 29.97 | 3003 |

When all the PTS cycles of the source video have been passed through, the first cycle will be arrived at again. When arriving again at the first cycle, the first theoretical fragment/segment boundary timestamp will be at PTS=0 and in general there will be a PTS discontinuity in the frame rate reduced profiles at this transition to the first cycle. Since this occurs very infrequently, it may be considered a minor issue.

When building a lookup table this manner, in general it is not necessary to include all possible PTS values in lookup table 212. Rather, a limited set of evenly spread PTS values may be included in lookup table 212. In a particular embodiment, the interval between the PTS values (Table Interval) is given by:

Table Interval=Frame Length/#PTS Cycles
With: Frame Length=90000/Frame Rate

Table 4 below provides an example table interval for different frame rates.

TABLE 4

| FrameRate (Hz) | Table Interval |
|---|---|
| 25 | 16 |
| 50 | 8 |
| 29.97 | 1 |

One can see that for 29.97 Hz video all possible PTS values are used. For 25 Hz video, the table interval is 16. This means that when the first video frame starts at PTS value 0 it will never get a value between 0 and 16, or between 16 and 32, etc. Accordingly, all PTS values in the range 0 to 15 can be treated identically as if they were 0, all PTS values in the range 16 to 31 may be treated identically as if they were 64, and so on.

Instead of building lookup tables that contain all possible fragment and segment boundaries for all PTS cycles, a reduced lookup table 212 may be built that only contains the first PTS value of each PTS cycle. Given a source PTS value, the first PTS value in the PTS cycle (PTS First Frame) can be calculated as follows:

PTS First Frame=[(PTSₐ MOD Frame Length)DIV Table Interval]*Table Interval
With: MOD=modulo operation
   DIV=integer division operator
   PTSₐ=Source PTS value

The PTS First Frame value is then used to find the corresponding PTS cycle in lookup table 212 and the corresponding First Frame Fragment Sequence and First Frame Segment Sequence number of the first frame in the cycle. The First Frame Fragment Sequence is the location of the first video frame of the PTS cycle in the fragment. When the First Frame Fragment Sequence value is equal to 1, the video frame starts a fragment. The First Frame Segment Sequence is the location of the first video frame PTS cycle in the segment. When the First Frame Segment Sequence is equal to 1, the video frame starts a segment.

The transcoder then calculates the offset between PTS First Frame and PTSₐ in number of frames:

Frame Offset_{PTSa}=(PTSₐ−PTSFirstFrame)DIV FrameLength
The Fragment Sequence Number of PTSa is then calculated as:

Fragment Sequence_{PTSa}=[(First Frame Fragment Sequence−1+Frame Offset PTSₐ)MOD(Number Of Frames Per Fragment)]+1
With: Fragment Length=fragment duration in 90 kHz ticks
   First Frame Fragment Sequence is the sequence number obtained from lookup table 212.
   Number Of Frames Per Fragment=number of video frames in a fragment If the Fragment Sequence PTSa value is equal to 1, then the video frame with PTSa starts a fragment.

The SegmentSequenceNumber of PTSa is then calculated as:

Segment Sequence_{PTSa}=[(First Frame Segment Sequence−1+Frame Offset PTSₐ)MOD(Number Of Frames Per Fragment*N)]+1
With: First Frame Segment Sequence is the sequence number obtained from the lookup table.
   N=number of fragments/segment
If the Segment Sequence PTSa value is equal to 1, then the video frame with PTSa starts a segment.

The following table (Table 5) provides several examples of video synchronization lookup tables generated in accordance with the above-described procedures.

TABLE 5

| Input | | | Output | | |
|---|---|---|---|---|---|
| | Frame | | Fragment | | |
| Frame | Duration | | Duration | Fragment | #Fragments/ |
| Rate (Hz) | (90 kHz) | #frames/fragment | (90 kHz) | Duration (s) | Segment |
| 50 | 1800 | 96 | 172800 | 1.92 | 3 |

| #PTS_Cycles | Table Interval |
|---|---|
| 225 | 8 |

| PTSa | PTSFirstFrame | PTS Cycle | FrameOffsetPTSa |
|---|---|---|---|
| 518400 | 0 | 0 | 288 |

| | | #video | | | | |
|---|---|---|---|---|---|---|
| | | frames | | | | |
| | | (including | | | | |
| | | partial | | | | |
| | | frames) | | | First | First |
| | | started in | | | Fragment | Segment |
| | | this PTS | cumulative | | Sequence | Sequence |
| PTS cycle | PTSFirstFrame | cycle | #video frames | PTS cycle | number | number |
| 0 | 0 | 4772186 | 4772186 | 0 | 1 | 1 |
| 1 | 208 | 4772186 | 9544372 | 1 | 27 | 27 |
| 2 | 416 | 4772186 | 14316558 | 2 | 53 | 53 |
| 3 | 624 | 4772186 | 19088744 | 3 | 79 | 79 |
| 4 | 832 | 4772186 | 23860930 | 4 | 9 | 105 |
| 5 | 1040 | 4772186 | 28633116 | 5 | 35 | 131 |
| 6 | 1248 | 4772186 | 33405302 | 6 | 61 | 157 |
| 7 | 1456 | 4772186 | 38177488 | 7 | 87 | 183 |
| 8 | 1664 | 4772185 | 42949673 | 8 | 17 | 209 |
| 9 | 72 | 4772186 | 47721859 | 9 | 42 | 234 |
| 10 | 280 | 4772186 | 52494045 | 10 | 68 | 260 |
| 11 | 488 | 4772186 | 57266231 | 11 | 94 | 286 |
| 12 | 696 | 4772186 | 62038417 | 12 | 24 | 24 |
| 13 | 904 | 4772186 | 66810603 | 13 | 50 | 50 |
| 14 | 1112 | 4772186 | 71582789 | 14 | 76 | 76 |
| 15 | 1320 | 4772186 | 76354975 | 15 | 6 | 102 |
| 16 | 1528 | 4772186 | 81127161 | 16 | 32 | 128 |
| 17 | 1736 | 4772185 | 85899346 | 17 | 58 | 154 |
| 18 | 144 | 4772186 | 90671532 | 18 | 83 | 179 |
| 19 | 352 | 4772186 | 95443718 | 19 | 13 | 205 |
| 20 | 560 | 4772186 | 100215904 | 20 | 39 | 231 |
| 21 | 768 | 4772186 | 104988090 | 21 | 65 | 257 |
| 22 | 976 | 4772186 | 109760276 | 22 | 91 | 283 |
| 23 | 1184 | 4772186 | 114532462 | 23 | 21 | 21 |
| 24 | 1392 | 4772186 | 119304648 | 24 | 47 | 47 |
| 25 | 1600 | 4772185 | 124076833 | 25 | 73 | 73 |
| 26 | 8 | 4772186 | 128849019 | 26 | 2 | 98 |
| 27 | 216 | 4772186 | 133621205 | 27 | 28 | 124 |
| 28 | 424 | 4772186 | 138393391 | 28 | 54 | 150 |
| 29 | 632 | 4772186 | 143165577 | 29 | 80 | 176 |
| 30 | 840 | 4772186 | 147937763 | 30 | 10 | 202 |
| 31 | 1048 | 4772186 | 152709949 | 31 | 36 | 228 |
| 32 | 1256 | 4772186 | 157482135 | 32 | 62 | 254 |
| 33 | 1464 | 4772186 | 162254321 | 33 | 88 | 280 |
| 34 | 1672 | 4772185 | 167026506 | 34 | 18 | 18 |
| 35 | 80 | 4772186 | 171798692 | 35 | 43 | 43 |
| 36 | 288 | 4772186 | 176570878 | 36 | 69 | 69 |
| 37 | 496 | 4772186 | 181343064 | 37 | 95 | 95 |
| 38 | 704 | 4772186 | 186115250 | 38 | 25 | 121 |
| 39 | 912 | 4772186 | 190887436 | 39 | 51 | 147 |
| 40 | 1120 | 4772186 | 195659622 | 40 | 77 | 173 |
| 41 | 1328 | 4772186 | 200431808 | 41 | 7 | 199 |
| 42 | 1536 | 4772186 | 205203994 | 42 | 33 | 225 |
| 43 | 1744 | 4772185 | 209976179 | 43 | 59 | 251 |
| 44 | 152 | 4772186 | 214748365 | 44 | 84 | 276 |
| 45 | 360 | 4772186 | 219520551 | 45 | 14 | 14 |
| 46 | 568 | 4772186 | 224292737 | 46 | 40 | 40 |
| 47 | 776 | 4772186 | 229064923 | 47 | 66 | 66 |
| 48 | 984 | 4772186 | 233837109 | 48 | 92 | 92 |
| 49 | 1192 | 4772186 | 238609295 | 49 | 22 | 118 |
| 50 | 1400 | 4772186 | 243381481 | 50 | 48 | 144 |
| 51 | 1608 | 4772185 | 248153666 | 51 | 74 | 170 |
| 52 | 16 | 4772186 | 252925852 | 52 | 3 | 195 |
| 53 | 224 | 4772186 | 257698038 | 53 | 29 | 221 |
| 54 | 432 | 4772186 | 262470224 | 54 | 55 | 247 |
| 55 | 640 | 4772186 | 267242410 | 55 | 81 | 273 |
| 56 | 848 | 4772186 | 272014596 | 56 | 11 | 11 |
| 57 | 1056 | 4772186 | 276786782 | 57 | 37 | 37 |
| 58 | 1264 | 4772186 | 281558968 | 58 | 63 | 63 |
| 59 | 1472 | 4772186 | 286331154 | 59 | 89 | 89 |
| 60 | 1680 | 4772185 | 291103339 | 60 | 19 | 115 |
| 61 | 88 | 4772186 | 295875525 | 61 | 44 | 140 |
| 62 | 296 | 4772186 | 300647711 | 62 | 70 | 166 |
| 63 | 504 | 4772186 | 305419897 | 63 | 96 | 192 |
| 64 | 712 | 4772186 | 310192083 | 64 | 26 | 218 |
| 65 | 920 | 4772186 | 314964269 | 65 | 52 | 244 |
| 66 | 1128 | 4772186 | 319736455 | 66 | 78 | 270 |
| 67 | 1336 | 4772186 | 324508641 | 67 | 8 | 8 |
| 68 | 1544 | 4772186 | 329280827 | 68 | 34 | 34 |
| 69 | 1752 | 4772185 | 334053012 | 69 | 60 | 60 |
| 70 | 160 | 4772186 | 338825198 | 70 | 85 | 85 |
| 71 | 368 | 4772186 | 343597384 | 71 | 15 | 111 |
| 72 | 576 | 4772186 | 348369570 | 72 | 41 | 137 |
| 73 | 784 | 4772186 | 353141756 | 73 | 67 | 163 |
| 74 | 992 | 4772186 | 357913942 | 74 | 93 | 189 |
| 75 | 1200 | 4772186 | 362686128 | 75 | 23 | 215 |
| 76 | 1408 | 4772186 | 367458314 | 76 | 49 | 241 |
| 77 | 1616 | 4772185 | 372230499 | 77 | 75 | 267 |
| 78 | 24 | 4772186 | 377002685 | 78 | 4 | 4 |
| 79 | 232 | 4772186 | 381774871 | 79 | 30 | 30 |
| 80 | 440 | 4772186 | 386547057 | 80 | 56 | 56 |
| 81 | 648 | 4772186 | 391319243 | 81 | 82 | 82 |
| 82 | 856 | 4772186 | 396091429 | 82 | 12 | 108 |
| 83 | 1064 | 4772186 | 400863615 | 83 | 38 | 134 |
| 84 | 1272 | 4772186 | 405635801 | 84 | 64 | 160 |
| 85 | 1480 | 4772186 | 410407987 | 85 | 90 | 186 |
| 86 | 1688 | 4772185 | 415180172 | 86 | 20 | 212 |
| 87 | 96 | 4772186 | 419952358 | 87 | 45 | 237 |
| 88 | 304 | 4772186 | 424724544 | 88 | 71 | 263 |
| 89 | 512 | 4772186 | 429496730 | 89 | 1 | 1 |
| 90 | 720 | 4772186 | 434268916 | 90 | 27 | 27 |
| 91 | 928 | 4772186 | 439041102 | 91 | 53 | 53 |
| 92 | 1136 | 4772186 | 443813288 | 92 | 79 | 79 |
| 93 | 1344 | 4772186 | 448585474 | 93 | 9 | 105 |
| 94 | 1552 | 4772186 | 453357660 | 94 | 35 | 131 |
| 95 | 1760 | 4772185 | 458129845 | 95 | 61 | 157 |
| 96 | 168 | 4772186 | 462902031 | 96 | 86 | 182 |
| 97 | 376 | 4772186 | 467674217 | 97 | 16 | 208 |
| 98 | 584 | 4772186 | 472446403 | 98 | 42 | 234 |
| 99 | 792 | 4772186 | 477218589 | 99 | 68 | 260 |
| 100 | 1000 | 4772186 | 481990775 | 100 | 94 | 286 |
| 101 | 1208 | 4772186 | 486762961 | 101 | 24 | 24 |
| 102 | 1416 | 4772186 | 491535147 | 102 | 50 | 50 |
| 103 | 1624 | 4772185 | 496307332 | 103 | 76 | 76 |
| 104 | 32 | 4772186 | 501079518 | 104 | 5 | 101 |
| 105 | 240 | 4772186 | 505851704 | 105 | 31 | 127 |
| 106 | 448 | 4772186 | 510623890 | 106 | 57 | 153 |
| 107 | 656 | 4772186 | 515396076 | 107 | 83 | 179 |
| 108 | 864 | 4772186 | 520168262 | 108 | 13 | 205 |
| 109 | 1072 | 4772186 | 524940448 | 109 | 39 | 231 |
| 110 | 1280 | 4772186 | 529712634 | 110 | 65 | 257 |
| 111 | 1488 | 4772186 | 534484820 | 111 | 91 | 283 |
| 112 | 1696 | 4772185 | 539257005 | 112 | 21 | 21 |
| 113 | 104 | 4772186 | 544029191 | 113 | 46 | 46 |
| 114 | 312 | 4772186 | 548801377 | 114 | 72 | 72 |
| 115 | 520 | 4772186 | 553573563 | 115 | 2 | 98 |
| 116 | 728 | 4772186 | 558345749 | 116 | 28 | 124 |
| 117 | 936 | 4772186 | 563117935 | 117 | 54 | 150 |
| 118 | 1144 | 4772186 | 567890121 | 118 | 80 | 176 |
| 119 | 1352 | 4772186 | 572662307 | 119 | 10 | 202 |
| 120 | 1560 | 4772186 | 577434493 | 120 | 36 | 228 |
| 121 | 1768 | 4772185 | 582206678 | 121 | 62 | 254 |
| 122 | 176 | 4772186 | 586978864 | 122 | 87 | 279 |
| 123 | 384 | 4772186 | 591751050 | 123 | 17 | 17 |
| 124 | 592 | 4772186 | 596523236 | 124 | 43 | 43 |
| 125 | 800 | 4772186 | 601295422 | 125 | 69 | 69 |
| 126 | 1008 | 4772186 | 606067608 | 126 | 95 | 95 |
| 127 | 1216 | 4772186 | 610839794 | 127 | 25 | 121 |
| 128 | 1424 | 4772186 | 615611980 | 128 | 51 | 147 |
| 129 | 1632 | 4772185 | 620384165 | 129 | 77 | 173 |
| 130 | 40 | 4772186 | 625156351 | 130 | 6 | 198 |
| 131 | 248 | 4772186 | 629928537 | 131 | 32 | 224 |
| 132 | 456 | 4772186 | 634700723 | 132 | 58 | 250 |
| 133 | 664 | 4772186 | 639472909 | 133 | 84 | 276 |
| 134 | 872 | 4772186 | 644245095 | 134 | 14 | 14 |
| 135 | 1080 | 4772186 | 649017281 | 135 | 40 | 40 |
| 136 | 1288 | 4772186 | 653789467 | 136 | 66 | 66 |
| 137 | 1496 | 4772186 | 658561653 | 137 | 92 | 92 |
| 138 | 1704 | 4772185 | 663333838 | 138 | 22 | 118 |
| 139 | 112 | 4772186 | 668106024 | 139 | 47 | 143 |
| 140 | 320 | 4772186 | 672878210 | 140 | 73 | 169 |
| 141 | 528 | 4772186 | 677650396 | 141 | 3 | 195 |
| 142 | 736 | 4772186 | 682422582 | 142 | 29 | 221 |
| 143 | 944 | 4772186 | 687194768 | 143 | 55 | 247 |
| 144 | 1152 | 4772186 | 691966954 | 144 | 81 | 273 |
| 145 | 1360 | 4772186 | 696739140 | 145 | 11 | 11 |
| 146 | 1568 | 4772186 | 701511326 | 146 | 37 | 37 |
| 147 | 1776 | 4772185 | 706283511 | 147 | 63 | 63 |
| 148 | 184 | 4772186 | 711055697 | 148 | 88 | 88 |
| 149 | 392 | 4772186 | 715827883 | 149 | 18 | 114 |
| 150 | 600 | 4772186 | 720600069 | 150 | 44 | 140 |
| 151 | 808 | 4772186 | 725372255 | 151 | 70 | 166 |
| 152 | 1016 | 4772186 | 730144441 | 152 | 96 | 192 |
| 153 | 1224 | 4772186 | 734916627 | 153 | 26 | 218 |
| 154 | 1432 | 4772186 | 739688813 | 154 | 52 | 244 |
| 155 | 1640 | 4772185 | 744460998 | 155 | 78 | 270 |
| 156 | 48 | 4772186 | 749233184 | 156 | 7 | 7 |
| 157 | 256 | 4772186 | 754005370 | 157 | 33 | 33 |
| 158 | 464 | 4772186 | 758777556 | 158 | 59 | 59 |
| 159 | 672 | 4772186 | 763549742 | 159 | 85 | 85 |
| 160 | 880 | 4772186 | 768321928 | 160 | 15 | 111 |
| 161 | 1088 | 4772186 | 773094114 | 161 | 41 | 137 |
| 162 | 1296 | 4772186 | 777866300 | 162 | 67 | 163 |
| 163 | 1504 | 4772186 | 782638486 | 163 | 93 | 189 |
| 164 | 1712 | 4772185 | 787410671 | 164 | 23 | 215 |
| 165 | 120 | 4772186 | 792182857 | 165 | 48 | 240 |
| 166 | 328 | 4772186 | 796955043 | 166 | 74 | 266 |
| 167 | 536 | 4772186 | 801727229 | 167 | 4 | 4 |
| 168 | 744 | 4772186 | 806499415 | 168 | 30 | 30 |
| 169 | 952 | 4772186 | 811271601 | 169 | 56 | 56 |
| 170 | 1160 | 4772186 | 816043787 | 170 | 82 | 82 |
| 171 | 1368 | 4772186 | 820815973 | 171 | 12 | 108 |
| 172 | 1576 | 4772186 | 825588159 | 172 | 38 | 134 |
| 173 | 1784 | 4772185 | 830360344 | 173 | 64 | 160 |
| 174 | 192 | 4772186 | 835132530 | 174 | 89 | 185 |
| 175 | 400 | 4772186 | 839904716 | 175 | 19 | 211 |
| 176 | 608 | 4772186 | 844676902 | 176 | 45 | 237 |
| 177 | 816 | 4772186 | 849449088 | 177 | 71 | 263 |
| 178 | 1024 | 4772186 | 854221274 | 178 | 1 | 1 |
| 179 | 1232 | 4772186 | 858993460 | 179 | 27 | 27 |
| 180 | 1440 | 4772186 | 863765646 | 180 | 53 | 53 |
| 181 | 1648 | 4772185 | 868537831 | 181 | 79 | 79 |
| 182 | 56 | 4772186 | 873310017 | 182 | 8 | 104 |
| 183 | 264 | 4772186 | 878082203 | 183 | 34 | 130 |
| 184 | 472 | 4772186 | 882854389 | 184 | 60 | 156 |
| 185 | 680 | 4772186 | 887626575 | 185 | 86 | 182 |
| 186 | 888 | 4772186 | 892398761 | 186 | 16 | 208 |
| 187 | 1096 | 4772186 | 897170947 | 187 | 42 | 234 |
| 188 | 1304 | 4772186 | 901943133 | 188 | 68 | 260 |
| 189 | 1512 | 4772186 | 906715319 | 189 | 94 | 286 |
| 190 | 1720 | 4772185 | 911487504 | 190 | 24 | 24 |
| 191 | 128 | 4772186 | 916259690 | 191 | 49 | 49 |
| 192 | 336 | 4772186 | 921031876 | 192 | 75 | 75 |
| 193 | 544 | 4772186 | 925804062 | 193 | 5 | 101 |
| 194 | 752 | 4772186 | 930576248 | 194 | 31 | 127 |
| 195 | 960 | 4772186 | 935348434 | 195 | 57 | 153 |
| 196 | 1168 | 4772186 | 940120620 | 196 | 83 | 179 |
| 197 | 1376 | 4772186 | 944892806 | 197 | 13 | 205 |
| 198 | 1584 | 4772186 | 949664992 | 198 | 39 | 231 |
| 199 | 1792 | 4772185 | 954437177 | 199 | 65 | 257 |
| 200 | 200 | 4772186 | 959209363 | 200 | 90 | 282 |
| 201 | 408 | 4772186 | 963981549 | 201 | 20 | 20 |
| 202 | 616 | 4772186 | 968753735 | 202 | 46 | 46 |
| 203 | 824 | 4772186 | 973525921 | 203 | 72 | 72 |
| 204 | 1032 | 4772186 | 978298107 | 204 | 2 | 98 |
| 205 | 1240 | 4772186 | 983070293 | 205 | 28 | 124 |
| 206 | 1448 | 4772186 | 987842479 | 206 | 54 | 150 |
| 207 | 1656 | 4772185 | 992614664 | 207 | 80 | 176 |
| 208 | 64 | 4772186 | 997386850 | 208 | 9 | 201 |
| 209 | 272 | 4772186 | 1002159036 | 209 | 35 | 227 |
| 210 | 480 | 4772186 | 1006931222 | 210 | 61 | 253 |
| 211 | 688 | 4772186 | 1011703408 | 211 | 87 | 279 |
| 212 | 896 | 4772186 | 1016475594 | 212 | 17 | 17 |
| 213 | 1104 | 4772186 | 1021247780 | 213 | 43 | 43 |
| 214 | 1312 | 4772186 | 1026019966 | 214 | 69 | 69 |
| 215 | 1520 | 4772186 | 1030792152 | 215 | 95 | 95 |
| 216 | 1728 | 4772185 | 1035564337 | 216 | 25 | 121 |
| 217 | 136 | 4772186 | 1040336523 | 217 | 50 | 146 |
| 218 | 344 | 4772186 | 1045108709 | 218 | 76 | 172 |
| 219 | 552 | 4772186 | 1049880895 | 219 | 6 | 198 |
| 220 | 760 | 4772186 | 1054653081 | 220 | 32 | 224 |
| 221 | 968 | 4772186 | 1059425267 | 221 | 58 | 250 |
| 222 | 1176 | 4772186 | 1064197453 | 222 | 84 | 276 |
| 223 | 1384 | 4772186 | 1068969639 | 223 | 14 | 14 |
| 224 | 1592 | 4772185 | 1073741824 | 224 | 40 | 40 |
| 225 | 0 | 4772186 | 1078514010 | 225 | 65 | 65 |

Complications with 59.54 Hz Progressive Video

When the input video source is 59.54 Hz video (e.g. 720p59.94) an issue that may arise with this procedure is that the PTS increment for 59.94 Hz video is either 1501 or 1502 (1501.5 on average). Building a lookup table 212 for this non-constant PTS increment brings a further complication. To perform the table lookup for 59.94 Hz video, in one embodiment only the PTS values that differ by either 1501 or 1502 compared to the previous value (in transcoding order—i.e. at the output of the transcoder) are considered. By doing so only every other PTS value will be used for table lookup, which makes it possible to perform a lookup in a half-rate table.

Complications with Sources Containing Field Pictures

Another complication that may occur is with sources that are coded as field pictures. The PTS increment for the pictures in these sources is only half the PTS increment of frame coded pictures. When transcoding these sources to progressive video, the PTS of the output frames will increase by the frame increment. This means that only half of the input PTS values are actually present in the transcoded output. In one particular embodiment, a solution to this issue includes first determining whether the source is coded as Top-Field-First (TFF) or Bottom-Field-First (BFF). For field coded pictures, this can be done by checking the first I-picture at the start of a GOP. If the first picture is a top field then the field order is TFF, otherwise it is BFF. In the case of TFF field order, only the top fields are considered when performing table lookups. In the case of BFF field order, only the bottom fields are considered when performing table lookups. In an alternative embodiment, the reconstructed frames at the output of the transcoder are considered and use the PTS values after the transcoder to perform the table lookup.

Complications with 3/2 Pull-Down 29.97 Hz Sources

For 29.97 Hz interlaced sources that originate from film content and that are intended to be 3/2 pulled down in the transcoder (i.e. converted from 24 fps to 30 fps), the PTS increment of the source frames is not constant because of the fact that some frames last 2 field periods while others last 3 field periods. When transcoding these sources to progressive video, the sequence is first converted to 29.97 Hz video in the transcoder (3/2 pull-down) and afterwards the frame rate of the 29.97 Hz video sequence is reduced. Because of the 3/2 pull-down manner of decoding the source, not all output PTS values are present in the source. For these sources the standard 29.97 Hz table is used. The PTS values that are used for table lookup however are the PTS values at the output of the transcoder, i.e. after the transcoder has converted the source to 29.97 Hz.

Robustness Against Source PTS Errors

Although the second video synchronization procedure described above gives better performance on PTS cycle wraps, it may be less robust against errors in the source video since it assumes a constant PTS increment in the source video. Consider, for example, a 29.97 Hz source where the PTS increment is not constant but varies by +/−1 tick. Depending upon the actual nature of the errors, the result for the first procedure may be that every now and then the fragment/segment duration is one frame more or less, which may not be a significant issue although there will be a PTS discontinuity in the frame rate reduced profiles. However, for the second procedure there may be a jump to a different PTS cycle each time the input PTS differs 1 tick from the expected value, which may result each time in a new fragment/segment. In such situations, it may be more desirable to use the first procedure for video synchronization as described above.

Audio Synchronization Procedure

As previously discussed audio synchronization may be slightly more complex than video synchronization since the synchronization should be done on two levels: the audio encoding framing level and the audio sample level. Fragments should start with a new audio frame and corresponding fragments of the different profiles should start with exactly the same audio sample. When transcoding audio from one compression standard to another the number of samples per frame is in general not the same. The following table (Table 6) gives an overview of frame size for some commonly used audio standards (AAC, MP1Lll, AC3, HE-ACC):

TABLE 6

| | #samples/frame |
|---|---|
| AAC | 1024 |
| MP1LII | 1152 |
| AC3 | 1536 |
| HE-AAC | 2048 |

Accordingly, when transcoding from one audio standard to another, the audio frame boundaries often cannot be maintained, i.e. an audio sample that starts an audio frame at the input will in general not start an audio frame at the output. When two different transcoders transcode the audio, the resulting frames will in general not be identical which will make it difficult to generate the different ABR profiles on different transcoders. In order to solve this issue, in at least one embodiment, a number of audio transcoding rules are used to instruct the transcoder how to map input audio samples to output audio frames.

In one or more embodiments, the audio transcoding rules may have the following limitations: limited support for audio sample rate conversion, i.e. the sample rate at the output is equal to the sample rate at the input, although some sample rate conversions can be supported (e.g. 48 kHz to 24 kHz), and no support for audio that is not locked to a System Time Clock (STC). Although it should be understood that in other embodiments, such limitations may not be present.

First Audio Re-Framing Procedure

As explained above the number of audio samples per frame is different for each audio standard. However, according to an embodiment of a procedure for audio re-framing it is always possible to map m frames of standard x into n frames of standard y.

This may be calculated as follows:

m=lcm(#samples/frameₓ,#samples/frame_{y})/#samples/frameₓ

n=lcm(#samples/frameₓ,#samples/frame_{y})/#samples/frame_{y}

The following table (Table 7) gives the m and n results when transcoding from AAC, AC3, MP1Lll or HE-AAC (=standard x) to AAC (=standard y):

TABLE 7

Standard y: AAC

| | | m | n |
|---|---|---|---|
| Standard x | AAC | 1 | 1 |
| | MP1LII | 8 | 9 |
| | AC3 | 2 | 3 |
| | HE-AAC | 1 | 2 |

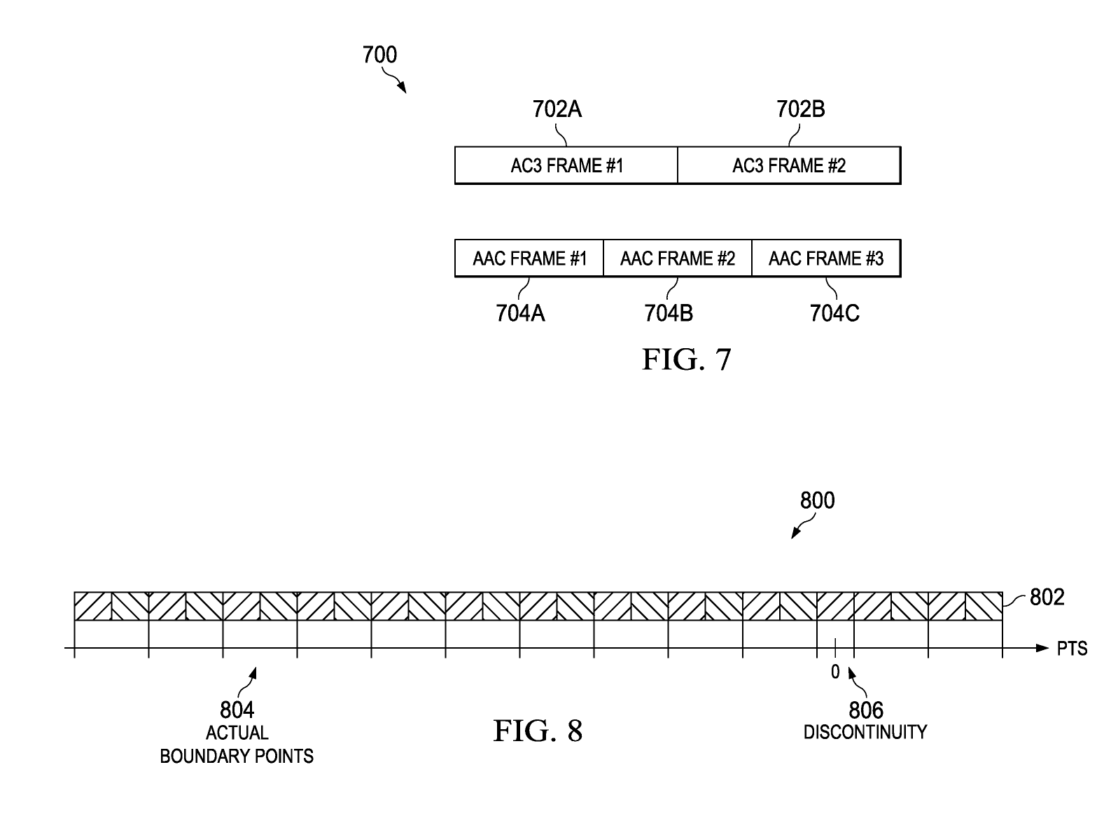

For example, when transcoding from AC3 to AAC, two AC3 frames will generate exactly 3 AAC frames. FIG. 7 is a simplified diagram 700 of an example conversion of two AC-3 audio frames 702a-702b to three AAC audio frames 704a, 704b, 704c in accordance with one embodiment. It should be noted that the first sample of AC3 Frame#1 (702a) will be the first sample of AAC Frame#1 (702a).

Accordingly, a first audio transcoding rule generates an integer amount of frames at the output from an integer amount of frames of the input. The first sample of the first frame of the input standard will also start the first frame of the output standard. The remaining issue is how to determine if a frame at the input is the first frame or not since only the first sample of the first frame at the input should start a new frame at the output. In at least one embodiment, determining if an input frame is the first frame or not is performed based on the PTS value of the input frame.

Theoretical Audio Re-Framing Boundaries

In accordance with various embodiments, audio re-framing boundaries in the first audio re-framing procedure are determined in a similar manner as for the first video fragmentation/segmentation procedure. First, the theoretical audio re-framing boundaries based on source PTS values are defined:
The first theoretical re-framing boundary timestamp starts at: PTS_RF_{theo[1]}=0
Theoretical re-framing boundary timestamp n starts at: PTS_RF_{theo[n]}=(n−1)*m*Audio Frame Length
   With: Audio Frame Length=audio frame length in 90 kHz ticks
      m=number of grouped source audio frames needed for re-framing

Some examples of audio frame durations are depicted in the following table (Table 8).

TABLE 8

| | | Duration @ 48 kHz | Audio Framelength |
|---|---|---|---|
| | #samples/frame | (s) | (90 kHz ticks) |
| AAC | 1024 | 0.021333333 | 1920 |
| MP1LII | 1152 | 0.024 | 2160 |
| AC3 | 1536 | 0.032 | 2880 |
| HE-AAC | 2048 | 0.042666667 | 3840 |

Actual Audio Re-Framing Boundaries

In the previous section, calculation of theoretical re-framing boundaries were described. The theoretical boundaries are used to determine the actual re-framing boundaries which is performed as follows: the first incoming actual PTS value that is greater than or equal to PTS_RF_{theo[n]} determines an actual re-framing boundary timestamp.

PTS Wrap Point

Referring now to FIG. 8, FIG. 8 shows a timeline diagram 800 of an audio sample discontinuity due to timestamp wrap in accordance with one embodiment. As previously discussed, an issue with using PTS as the time reference for audio re-frame synchronization is that it wraps after about 26.5 hours. In general one PTS cycle will not contain an integer number of groups of m source audio frames. Therefore, at the end of the PTS cycle there will be a discontinuity in the audio re-framing. The last audio frame in the cycle will not correctly end the re-framing operation and the next audio frame in the new cycle will re-start the audio re-framing operation. FIG. 8 shows a number of sequential audio frames 802 having actual boundary points 804 along the PTS timeline. At a PTS wrap point, a discontinuity 806 occurs. This discontinuity 806 will in general generate an audio glitch on the client device depending upon the capabilities of the client device to handle such discontinuities.

Second Audio Re-Framing Procedure

An issue with the first audio re-framing procedure discussed above is that there may be an audio glitch at the PTS wrap point (See FIG. 8). This issue can be addressed by considering multiple PTS cycles. When taking multiple PTS cycles into consideration it is possible to fit an integer amount of m input audio frames. The number of PTS cycles needed to fit an integer amount of m audio frames is calculated as follows:

#PTS_Cycles=lcm(2̂33,m*AudioFrameLength)/2̂33

An example for AC3 to AAC @ 48 kHz is as follows: #PTS_Cycles=lcm(2̂33, 2*2880)/233=45. This means that 45 PTS cycles fit an integer amount of 2 AC3 input audio frames.

Next, an audio re-framing rule is defined that runs over multiple PTS cycles. The rule includes a lookup in a lookup table that runs over multiple PTS cycles (# cycles=#PTS_Cycles). In one embodiment, the table may be calculated in real-time by the transcoder or in other embodiments, the table may be calculated off-line and used as a look-up table such as lookup table 212.

In order to calculate the lookup table, the procedure starts from the first PTS cycle (cycle 0) and it is arbitrarily assumed that the first audio frame starts at PTS value 0. It is also arbitrarily assumed that the first audio sample of this first frame starts a new audio frame at the output. For each consecutive PTS cycle the current location in the audio frame numbering is calculated. In a particular embodiment, audio frame numbering increments from 1 to m in which the first sample of frame number 1 starts a frame at the output.

An example of a resulting table (Table 9) for AC3 formatted input audio at 48 kHz is as follows:

TABLE 9

| | | | #audio | | |
|---|---|---|---|---|---|
| | | | frames | | |
| | | | (including | | |
| | | | partial | | |
| | | | frames | | First |
| | | | started in | cumulative | Frame |
| PTS | | | this PTS | #audio | Sequence |
| cycle | PTS_{FirstFrame} | PTS_{LastFrame} | cycle) | frames | Number |
| 0 | 0 | 8589934080 | 2982617 | 2982617 | 1 |
| 1 | 2368 | 8589933568 | 2982616 | 5965233 | 2 |
| 2 | 1856 | 8589933056 | 2982616 | 8947849 | 2 |
| 3 | 1344 | 8589932544 | 2982616 | 11930465 | 2 |
| 4 | 832 | 8589932032 | 2982616 | 14913081 | 2 |
| 5 | 320 | 8589934400 | 2982617 | 17895698 | 2 |
| 6 | 2688 | 8589933888 | 2982616 | 20878314 | 1 |
| 7 | 2176 | 8589933376 | 2982616 | 23860930 | 1 |
| 8 | 1664 | 8589932864 | 2982616 | 26843546 | 1 |
| 9 | 1152 | 8589932352 | 2982616 | 29826162 | 1 |
| 10 | 640 | 8589931840 | 2982616 | 32808778 | 1 |
| 11 | 128 | 8589934208 | 2982617 | 35791395 | 1 |
| 12 | 2496 | 8589933696 | 2982616 | 38774011 | 2 |
| 13 | 1984 | 8589933184 | 2982616 | 41756627 | 2 |
| 14 | 1472 | 8589932672 | 2982616 | 44739243 | 2 |
| 15 | 960 | 8589932160 | 2982616 | 47721859 | 2 |
| 16 | 448 | 8589934528 | 2982617 | 50704476 | 2 |
| 17 | 2816 | 8589934016 | 2982616 | 53687092 | 1 |
| 18 | 2304 | 8589933504 | 2982616 | 56669708 | 1 |
| 19 | 1792 | 8589932992 | 2982616 | 59652324 | 1 |
| 20 | 1280 | 8589932480 | 2982616 | 62634940 | 1 |
| 21 | 768 | 8589931968 | 2982616 | 65617556 | 1 |
| 22 | 256 | 8589934336 | 2982617 | 68600173 | 1 |
| 23 | 2624 | 8589933824 | 2982616 | 71582789 | 2 |
| 24 | 2112 | 8589933312 | 2982616 | 74565405 | 2 |
| 25 | 1600 | 8589932800 | 2982616 | 77548021 | 2 |
| 26 | 1088 | 8589932288 | 2982616 | 80530637 | 2 |
| 27 | 576 | 8589931776 | 2982616 | 83513253 | 2 |
| 28 | 64 | 8589934144 | 2982617 | 86495870 | 2 |
| 29 | 2432 | 8589933632 | 2982616 | 89478486 | 1 |
| 30 | 1920 | 8589933120 | 2982616 | 92461102 | 1 |
| 31 | 1408 | 8589932608 | 2982616 | 95443718 | 1 |
| 32 | 896 | 8589932096 | 2982616 | 98426334 | 1 |
| 33 | 384 | 8589934464 | 2982617 | 101408951 | 1 |
| 34 | 2752 | 8589933952 | 2982616 | 104391567 | 2 |
| 35 | 2240 | 8589933440 | 2982616 | 107374183 | 2 |
| 36 | 1728 | 8589932928 | 2982616 | 110356799 | 2 |
| 37 | 1216 | 8589932416 | 2982616 | 113339415 | 2 |
| 38 | 704 | 8589931904 | 2982616 | 116322031 | 2 |
| 39 | 192 | 8589934272 | 2982617 | 119304648 | 2 |
| 40 | 2560 | 8589933760 | 2982616 | 122287264 | 1 |
| 41 | 2048 | 8589933248 | 2982616 | 125269880 | 1 |
| 42 | 1536 | 8589932736 | 2982616 | 128252496 | 1 |
| 43 | 1024 | 8589932224 | 2982616 | 131235112 | 1 |
| 44 | 512 | 8589931712 | 2982616 | 134217728 | 1 |
| 45 | 0 | 8589934080 | 2982617 | 137200345 | 1 |

As can be seen in Table 9, the table repeats after 45 PTS cycles.

In various embodiments, when building a table in this manner, in general it is not necessary to use all possible PTS values but rather a limited set of evenly spread PTS values. In a particular embodiment, the interval between the PTS values is given by: Table Interval=AudioFrameLength/#PTS_Cycles

For AC3 @48 kHz, the Table Interval=2880/45=64. This means that when the first audio frame starts at PTS value 0 it will never get a value between 0 and 64, or between 64 and 128, etc. This means that all PTS values in the range 0-63 can be treated identically as if they were 0, all PTS values in the range 64-127 are treated identically as if they were 64, and so on.

This is depicted in the following simplified table (Table 10).

TABLE 10

| | | | First |
|---|---|---|---|
| PTS | First Frame | | Frame |
| cycle | PTS range | PTS_{FirstFrame} | Sequence # |
| 0 | 0 . . . 63 | 0 | 1 |
| 1 | 2368 . . . 2431 | 2368 | 2 |
| 2 | 1856 . . . 1919 | 1856 | 2 |
| 3 | 1344 . . . 1407 | 1344 | 2 |
| 4 | 832 . . . 895 | 832 | 2 |
| 5 | 320 . . . 383 | 320 | 2 |
| 6 | 2688 . . . 2751 | 2688 | 1 |
| 7 | 2176 . . . 2239 | 2176 | 1 |
| 8 | 1664 . . . 1727 | 1664 | 1 |
| 9 | 1152 . . . 1215 | 1152 | 1 |
| 10 | 640 . . . 703 | 640 | 1 |
| 11 | 128 . . . 191 | 128 | 1 |
| 12 | 2496 . . . 2559 | 2496 | 2 |
| 13 | 1984 . . . 2047 | 1984 | 2 |
| 14 | 1472 . . . 1535 | 1472 | 2 |
| 15 | 960 . . . 1023 | 960 | 2 |
| 16 | 448 . . . 511 | 448 | 2 |
| 17 | 2816 . . . 2879 | 2816 | 1 |
| 18 | 2304 . . . 2367 | 2304 | 1 |
| 19 | 1792 . . . 1855 | 1792 | 1 |
| 20 | 1280 . . . 1343 | 1280 | 1 |
| 21 | 768 . . . 831 | 768 | 1 |
| 22 | 256 . . . 319 | 256 | 1 |
| 23 | 2624 . . . 2687 | 2624 | 2 |
| 24 | 2112 . . . 2175 | 2112 | 2 |
| 25 | 1600 . . . 1663 | 1600 | 2 |
| 26 | 1088 . . . 1151 | 1088 | 2 |
| 27 | 576 . . . 639 | 576 | 2 |
| 28 | 64 . . . 127 | 64 | 2 |
| 29 | 2432 . . . 2495 | 2432 | 1 |
| 30 | 1920 . . . 1983 | 1920 | 1 |
| 31 | 1408 . . . 1471 | 1408 | 1 |
| 32 | 896 . . . 959 | 896 | 1 |
| 33 | 384 . . . 447 | 384 | 1 |
| 34 | 2752 . . . 2815 | 2752 | 2 |
| 35 | 2240 . . . 2303 | 2240 | 2 |
| 36 | 1728 . . . 1791 | 1728 | 2 |
| 37 | 1216 . . . 1279 | 1216 | 2 |
| 38 | 704 . . . 767 | 704 | 2 |
| 39 | 192 . . . 255 | 192 | 2 |
| 40 | 2560 . . . 2623 | 2560 | 1 |
| 41 | 2048 . . . 2111 | 2048 | 1 |
| 42 | 1536 . . . 1599 | 1536 | 1 |
| 43 | 1024 . . . 1087 | 1024 | 1 |
| 44 | 512 . . . 575 | 512 | 1 |

When a transcoder starts up and begins transcoding audio it receives an audio frame with a certain PTS value designated as PTSₐ. The first calculation that is performed is to find out where this PTS value (PTSₐ) fits in the lookup table and what the sequence number of this frame is in order to know whether this frame starts an output frame or not.

In order to do so, the corresponding first frame is calculated as follows:

PTS_{First Frame}=[(PTSₐ MOD Audio Frame Length)DIV Table Interval]*Table Interval
With: DIV=integer division operator

The PTS First Frame value is then used to find the corresponding PTS cycle in the table and the corresponding First Frame Sequence Number.

The transcoder then calculates the offset between PTS First Frame and PTSa in number of frames as follows:

Frame Offset_{PTSa}=(PTSₐ−PTS_{First Frame})DIV Audio Frame Length

The sequence number of PTSa is then calculated as:

Sequence_{PTSa}=[(First Frame Sequence Number−1+FrameOffset_{PTsa})MOD m]+1
With: First Frame Sequence Number is the sequence number obtained from the lookup table.

If Sequence_{PTSa} is equal to 1 then the first audio sample of this input frame starts a new output frame. For example, assume a transcoder transcodes from AC3 to AAC at a 48 kHz sample rate. The first received audio frame has a PTS value equal to 4000. The PTS First Frame is determined as follows: PTS First Frame=(4000 MOD 2880) DIV (2880/45)*(2880/45)=1088
From the Look-up table (Table 9):

First Frame Sequence Number=2

Frame Offset PTSa=(4000−1088)DIV 2880=1

Sequence PTSa=[(2−1+1)MOD 2]+1=1
In accordance with various embodiments, the first audio sample of this input audio frame starts a new frame at the output.

Transcoded Audio Fragment Synchronization

In the previous sections a procedure was described to deterministically build new audio frames after transcoding of an audio source. The re-framing procedure makes sure that different transcoders generate audio frames that start with the same audio sample. For some ABR standards, there is a requirement that transcoded audio streams are fragmented (i.e. fragment boundaries are signaled in the audio stream) and different transcoders should insert the fragment boundaries at exactly the same audio frame boundary.

A procedure to synchronize audio fragmentation in at least one embodiment is to align the audio fragment boundaries with the re-framing boundaries. As discussed herein above, in at least one embodiment for every m input frames the re-framing is started based on the theoretical boundaries in a look-up table. The look-up table may be expanded to also include the fragment synchronization boundaries. Assuming the minimum distance between two fragments is m, the fragment boundaries can be made longer by only inserting a fragment every x re-framing boundaries, which means only 1 out of x re-framing boundaries is used as a fragment boundary, resulting in fragment lengths of m*x audio frames. Determining whether a re-framing boundary is also a fragmentation boundary is performed by extending the re-framing look-up table with the fragmentation boundaries. It should be noted that in general if x is different from 1, the fragmentation boundaries will not perfectly fit into the multi-PTS re-framing cycles and will result in a shorter than normal fragment at the multi-PTS cycle wrap.

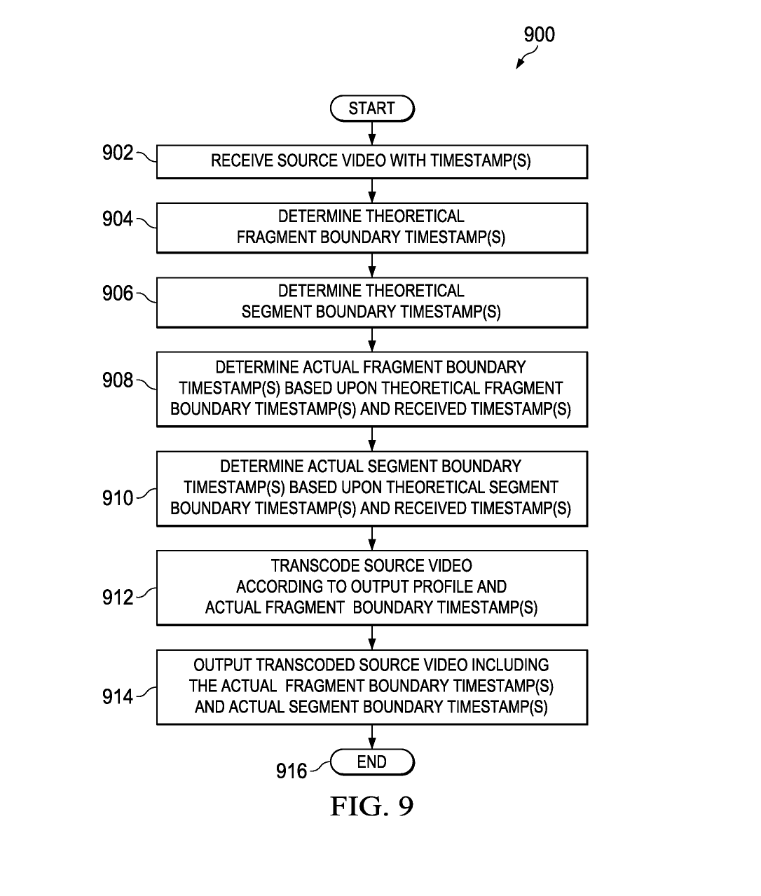

Referring now to FIG. 9, FIG. 9 is a simplified flowchart 900 illustrating one potential video synchronization operation associated with the present disclosure. In 902, one or more of first transcoder device 104a, second transcoder device 104b, and third transcoder device 104c receives source video comprised of one or more video frames with associated video timestamps. In a particular embodiment, the source video is MPEG video and the video timestamps are Presentation Time Stamp (PTS) values. In at least one embodiment, the source video is received by first transcoder device 104a from video/audio source 102. In at least one embodiment, first transcoder device 104a includes one or more output video profiles indicating a particular bitrate, framerate, and/or video encoding format for which the first transcoder device 104a is to output transcoded video.

In 904, first transcoder device 104a determines theoretical fragment boundary timestamps based upon one or more characteristics of the source video using one or more of the procedures as previously described herein. In a particular embodiment, the one or more characteristics include one or more of a fragment duration and a frame rate associated with the source video. In still other embodiments, the theoretical fragment boundary timestamps may be further based upon frame periods associated with a number of output profiles associated with one or more of first transcoder device 104a, second transcoder device 104b, and third transcoder device 104c. In a particular embodiment, the theoretical fragment boundary timestamps are a function of a least common multiple of a plurality of frame periods associated with respective output profiles. In some embodiments, the theoretical fragment boundary timestamps may be obtained from a lookup table 212. In 906, first transcoder device 104a determines theoretical segment boundary timestamps based upon one or more characteristics of the source video using one or more of the procedures as previously discussed herein. In a particular embodiment, the one or more characteristics include one or more of a segment duration and frame rate of associated with the source video.

In 908, first transcoder device 104a determines the actual fragment boundary timestamps based upon the theoretical fragment boundary timestamps and received timestamps from the source video using one or more of the procedures as previously described herein. In a particular embodiment, the first incoming actual timestamp value that is greater than or equal to the particular theoretical fragment boundary timestamp determines the actual fragment boundary timestamp. In 910, first transcoder device 104a determines the actual segment boundary timestamps based upon the theoretical segment boundary timestamps and the received timestamps from the source video using one or more of the procedures as previously described herein.

In 912, first transcoder device 104a transcodes the source video according to the output profile and the actual fragment boundary timestamps using one or more procedures as discussed herein. In 914, first transcoder device 104a outputs the transcoded source video including the actual fragment boundary timestamps and actual segment boundary timestamps. In at least one embodiment, the transcoded source video is sent by first transcoder device 104a to encapsulator device 105. Encapsulator device 105 encapsulated the transcoded source video and sends the encapsulated transcoded source video to media server 106. Media server 106 stores the encapsulated transcoded source video in storage device 108. In one or more embodiments, first transcoder device 104a signals the chunk (fragment/segment) boundaries in a bitstream sent to encapsulator device 105 and encapsulator device 105 for use by the encapsulator device 105 during the encapsulation.

It should be understood that the video synchronization operations may also be performed on the source video by one or more of second transcoder device 104b and third transcoder device 104b in accordance with one or more output profiles such that the transcoded output video associated with each output profile may have different video formats, resolutions, bitrates, and/or framerates associated therewith. At a later time, a selected one of the transcoded output video may be streamed to one or more of first destination device 110a and second destination device 110b according to available bandwidth. The operations end at 916.

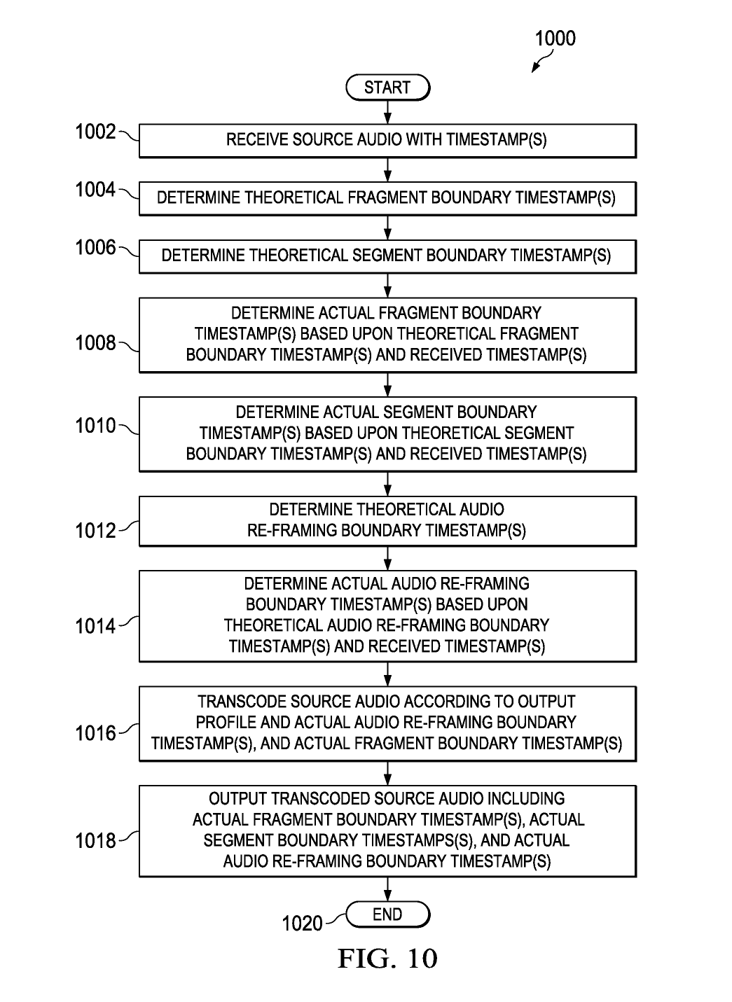

FIG. 10 is a simplified flowchart 1000 illustrating one potential audio synchronization operation associated with the present disclosure. In 1002, one or more of first transcoder device 104a, second transcoder device 104b, and third transcoder device 104c receives source audio comprised of one or more audio frames with associated audio timestamps. In a particular embodiment, the audio timestamps are Presentation Time Stamp (PTS) values. In at least one embodiment, the source audio is received by first transcoder device 104a from video/audio source 102. In at least one embodiment, first transcoder device 104a includes one or more output audio profiles indicating a particular bitrate, framerate, and/or audio encoding format for which the first transcoder device 104a is to output transcoded audio.

In 1004, first transcoder device 104a determines theoretical fragment boundary timestamps using one or more of the procedures as previously described herein. In 1006, first transcoder device 104a determines theoretical segment boundary timestamps using one or more of the procedures as previously discussed herein. In 1008, first transcoder device 104a determines the actual fragment boundary timestamps using one or more of the procedures as previously described herein. In a particular embodiment, the first incoming actual timestamp value that is greater than or equal to the particular theoretical fragment boundary timestamp determines the actual fragment boundary timestamp. In 1010, first transcoder device 104a determines the actual segment boundary timestamps based upon the theoretical segment boundary timestamps and the received timestamps from the source video using one or more of the procedures as previously described herein.

In 1012, first transcoder device 104a determines theoretical audio re-framing boundary timestamps based upon one or more characteristics of the source audio using one or more of the procedures as previously described herein. In a particular embodiment, the one or more characteristics include one or more of an audio frame length and a number of grouped source audio frames needed for re-framing associated with the source audio. In some embodiments, the theoretical audio re-framing boundary timestamps may be obtained from lookup table 212.

In 1014, first transcoder device 104a determines the actual audio re-framing boundary timestamps based upon the theoretical audio re-framing boundary timestamps and received audio timestamps from the source audio using one or more of the procedures as previously described herein. In a particular embodiment, the first incoming actual timestamp value that is greater than or equal to the particular theoretical audio re-framing boundary timestamp determines the actual audio re-framing boundary timestamp.

In 1016, first transcoder device 104a transcodes the source audio according to the output profile, the actual audio-reframing boundary timestamps, and the actual fragment boundary timestamps using one or more procedures as discussed herein. In 1018, first transcoder device 104a outputs the transcoded source audio including the actual audio re-framing boundary timestamps, actual fragment boundary timestamps, and the actual segment boundary timestamps. In at least one embodiment, the transcoded source audio is sent by first transcoder device 104a to encapsulator device 105. Encapsulator device 105 sends the encapsulated transcoded source audio to media server 106, and media server 106 stores the encapsulated transcoded source audio in storage device 108. In one or more embodiments, the transcoded source audio may be stored in association with related transcoded source video. It should be understood that the audio synchronization operations may also be performed on the source audio by one or more of second transcoder device 104b and third transcoder device 104b in accordance with one or more output profiles such that the transcoded output audio associated with each output profile may have different audio formats, bitrates, and/or framerates associated therewith. At a later time, a selected one of the transcoded output audio may be streamed to one or more of first destination device 110a and second destination device 110b according to available bandwidth. The operations end at 1012.

Note that in certain example implementations, the video/audio synchronization functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIG. 2] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIG. 2] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

In one example implementation, transcoder devices 104a-104c may include software in order to achieve the video/audio synchronization functions outlined herein. These activities can be facilitated by transcoder module(s) 208, video/audio timestamp alignment module 210, and/or lookup tables 212 where these modules can be suitably combined in any appropriate manner, which may be based on particular configuration and/or provisioning needs). Transcoder devices 104a-104c can include memory elements for storing information to be used in achieving the intelligent forwarding determination activities, as discussed herein. Additionally, transcoder devices 104a-104c may include a processor that can execute software or an algorithm to perform the video/audio synchronization operations, as disclosed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein (e.g., database, tables, trees, cache, etc.) should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the example provided above, as well as numerous other examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 (and its teachings) are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the steps in the preceding flow diagrams illustrate only some of the possible signaling scenarios and patterns that may be executed by, or within, communication system 100. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Additionally, although communication system 100 has been illustrated with reference to particular elements and operations that facilitate the communication process, these elements and operations may be replaced by any suitable architecture or process that achieves the intended functionality of communication system 100.

What is claimed is:

1. A method, comprising:
receiving source video including associated video timestamps;
determining a theoretical fragment boundary timestamp based upon one or more characteristics of the source video and the received video timestamps, the theoretical fragment boundary timestamp identifying a fragment including one or more video frames of the source video;
determining an actual fragment boundary timestamp based upon the theoretical fragment boundary timestamp and one or more of the received video timestamps;
transcoding the source video according to the actual fragment boundary timestamp; and
outputting the transcoded source video including the actual fragment boundary timestamp.

2. The method of claim 1, wherein the one or more characteristics of the source video include a fragment duration associated with the source video and a frame rate associated with the source video.

3. The method of claim 1, wherein determining the theoretical fragment boundary timestamp includes determining the theoretical fragment boundary timestamp from a lookup table.

4. The method of claim 1, wherein determining the actual fragment boundary timestamp includes determining the first received video timestamp that is greater than or equal to the theoretical fragment boundary timestamp.

5. The method of claim 1, further comprising:
determining a theoretical segment boundary timestamp based upon one or more characteristics of the source video and the received video timestamps, the theoretical segment boundary timestamp identifying a segment including one or more fragments of the source video; and
determining an actual segment boundary timestamp based upon the theoretical segment boundary timestamp and one or more of the received video timestamps.

6. The method of claim 1, further comprising:
receiving source audio including associated audio timestamps;
determining a theoretical re-framing boundary timestamp based upon one or more characteristics of the source audio;
determining an actual re-framing boundary timestamp based upon the theoretical audio re-framing boundary timestamp and one or more of the received audio timestamps;
transcoding the source audio according to the actual re-framing boundary timestamp; and
outputting the transcoded source audio including the actual re-framing boundary timestamp.

7. The method of claim 6, wherein determining the actual re-framing boundary timestamp includes determining the first received audio timestamp that is greater than or equal to the theoretical re-framing boundary timestamp.

8. Logic encoded in one or more tangible, non-transitory media that includes code for execution and when executed by a processor operable to perform operations, comprising:
receiving source video including associated video timestamps;
determining a theoretical fragment boundary timestamp based upon one or more characteristics of the source video and the received video timestamps, the theoretical fragment boundary timestamp identifying a fragment including one or more video frames of the source video;
determining an actual fragment boundary timestamp based upon the theoretical fragment boundary timestamp and one or more of the received video timestamps;
transcoding the source video according to the actual fragment boundary timestamp; and
outputting the transcoded source video including the actual fragment boundary timestamp.

9. The logic of claim 8, wherein the one or more characteristics of the source video include a fragment duration associated with the source video and a frame rate associated with the source video.

10. The logic of claim 8, wherein determining the theoretical fragment boundary timestamp includes determining the theoretical fragment boundary timestamp from a lookup table.

11. The logic of claim 8, wherein determining the actual fragment boundary timestamp includes determining the first received video timestamp that is greater than or equal to the theoretical fragment boundary timestamp.

12. The logic of claim 8, wherein the operations further comprise:
determining a theoretical segment boundary timestamp based upon one or more characteristics of the source video and the received video timestamps, the theoretical segment boundary timestamp identifying a segment including one or more fragments of the source video; and
determining an actual segment boundary timestamp based upon the theoretical segment boundary timestamp and one or more of the received video timestamps.

13. The logic of claim 8, wherein the operations further comprise:
receiving source audio including associated audio timestamps;
determining a theoretical re-framing boundary timestamp based upon one or more characteristics of the source audio;
determining an actual re-framing boundary timestamp based upon the theoretical audio re-framing boundary timestamp and one or more of the received audio timestamps;
transcoding the source audio according to the actual re-framing boundary timestamp; and
outputting the transcoded source audio including the actual re-framing boundary timestamp.

14. The logic of claim 13, wherein determining the actual re-framing boundary timestamp includes determining the first received audio timestamp that is greater than or equal to the theoretical re-framing boundary timestamp

15. An apparatus, comprising:
a memory element configured to store data;
a processor operable to execute instructions associated with the data; and
at least one module, the apparatus being configured to:
receive source video including associated video timestamps;
determine a theoretical fragment boundary timestamp based upon one or more characteristics of the source video and the received video timestamps, the theoretical fragment boundary timestamp identifying a fragment including one or more video frames of the source video;
determine an actual fragment boundary timestamp based upon the theoretical fragment boundary timestamp and one or more of the received video timestamps;
transcode the source video according to the actual fragment boundary timestamp; and
output the transcoded source video including the actual fragment boundary timestamp.

16. The apparatus of claim 15, wherein the one or more characteristics of the source video include a fragment duration associated with the source video and a frame rate associated with the source video.

17. The apparatus of claim 15, wherein determining the theoretical fragment boundary timestamp includes determining the theoretical fragment boundary timestamp from a lookup table.

18. The apparatus of claim 15, wherein determining the actual fragment boundary timestamp includes determining the first received video timestamp that is greater than or equal to the theoretical fragment boundary timestamp.

19. The apparatus of claim 15, wherein the apparatus is further configured to:
determine a theoretical segment boundary timestamp based upon one or more characteristics of the source video and the received video timestamps, the theoretical segment boundary timestamp identifying a segment including one or more fragments of the source video; and
determine an actual segment boundary timestamp based upon the theoretical segment boundary timestamp and one or more of the received video timestamps.

20. The apparatus of claim 15, wherein the apparatus is further configured to:
receive source audio including associated audio timestamps;
determine a theoretical re-framing boundary timestamp based upon one or more characteristics of the source audio;
determine an actual re-framing boundary timestamp based upon the theoretical audio re-framing boundary timestamp and one or more of the received audio timestamps;
transcode the source audio according to the actual re-framing boundary timestamp; and
output the transcoded source audio including the actual re-framing boundary timestamp.

21. The apparatus of claim 20, wherein determining the actual re-framing boundary timestamp includes determining the first received audio timestamp that is greater than or equal to the theoretical re-framing boundary timestamp.
